(19) United States
(12) Patent Application Publication
(10) Pub. No.: US 2024/0187576 A1
(43) Pub. Date: Jun. 6, 2024

(54) METHOD, APPARATUS, AND MEDIUM FOR VIDEO PROCESSING

(71) Applicants: Beijing Bytedance Network Technology Co., Ltd., Beijing (CN); Bytedance Inc., Los Angeles, CA (US)

(72) Inventors: Yang WANG, Beijing (CN); Kai ZHANG, Los Angeles, CA (US); Li ZHANG, Los Angeles, CA (US)

(21) Appl. No.: 18/438,028

(22) Filed: Feb. 9, 2024

Related U.S. Application Data
(63) Continuation of application No. PCT/CN2022/110866, filed on Aug. 8, 2022.

(30) Foreign Application Priority Data
Aug. 13, 2021 (WO) PCT/CN2021/112472

(51) Int. Cl. H04N 19/11; H04N 19/105; H04N 19/176; H04N 19/186

(52) U.S. Cl. CPC H04N 19/11; H04N 19/105; H04N 19/176; H04N 19/186

(57) ABSTRACT

Embodiments of the present disclosure provide a method for video processing. The method comprises: determining, during a conversion between a current chroma block of a video and a bitstream of the video, a set of target modes of cross component intra prediction (CCIP) for the current chroma block based on reconstructed samples or predicted samples of neighboring samples of the current chroma block; and performing the conversion based on the set of target modes. Compared with the conventional solution, the proposed method can advantageously improve coding efficiency.

### CROSS REFERENCE

This application is a continuation of International Application No. PCT/CN2022/110866, filed on Aug. 8, 2022, which claims the benefit of International Application No. PCT/CN2021/112472 filed on Aug. 13, 2021. The entire contents of these applications are hereby incorporated by reference in their entireties.

### FIELD

Embodiments of the present disclosure relates generally to video coding techniques, and more particularly, to mode derivation for cross component intra prediction.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding efficiency of conventional video coding techniques is generally expected to be further improved.

### SUMMARY

In a first aspect, a method for video processing is proposed. The method comprises: determining, during a conversion between a current chroma block of a video and a bitstream of the video, a set of target modes of cross component intra prediction (CCIP) for the current chroma block based on reconstructed samples or predicted samples of neighboring samples of the current chroma block; and performing the conversion based on the set of target modes.

According to the method in accordance with the first aspect of the present disclosure, a set of target modes of CCIP are derived based on reconstructed samples or predicted samples of neighboring samples of the current block, rather than being signaled in the bitstream. Thereby, the proposed method can advantageously improve coding efficiency and reduce the coding bits while maintaining the coding quality.

In a second aspect, an apparatus for processing video data is proposed. The apparatus for processing video data comprising a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium storing instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by a video processing apparatus. The method comprises: determining a set of target modes of CCIP for a current chroma block of the video based on reconstructed samples or predicted samples of neighboring samples of the current chroma block; and generating the bitstream based on the set of target modes.

In a fifth aspect, a method for storing a bitstream of a video is proposed. The method comprises: determining a set of target modes of CCIP for a current chroma block of the video based on reconstructed samples or predicted samples of neighboring samples of the current chroma block; generating the bitstream based on the set of target modes; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram of an example video coding system in accordance with some embodiments of the present disclosure;

FIG. 2 illustrates a block diagram of an example video encoder in accordance with some embodiments of the present disclosure;

FIG. 3 illustrates a block diagram of an example video decoder in accordance with some embodiments of the present disclosure;

FIG. 4 is a schematic diagram illustrating nominal vertical and horizontal locations of 4:2:2 luma and chroma samples in a picture;

FIG. 5 is a schematic diagram illustrating example of encoder block diagram;

FIG. 6 is a schematic diagram illustrating 67 intra prediction modes;

FIG. 7 is a schematic diagram illustrating reference samples for wide-angular intra prediction;

FIG. 8 is a schematic diagram illustrating problem of discontinuity in case of directions beyond 45°;

FIG. 9 is a schematic diagram illustrating locations of the samples used for the derivation of a and B;

FIG. 10 is a schematic diagram illustrating an example of classifying the neighboring samples into two groups;

FIG. 11A is a schematic diagram illustrating definition of samples used by PDPC applied to a diagonal top-right mode;

FIG. 11B is a schematic diagram illustrating definition of samples used by PDPC applied to a diagonal bottom-left mode;

FIG. 11C is a schematic diagram illustrating definition of samples used by PDPC applied to an adjacent diagonal top-right mode;

FIG. 11D is a schematic diagram illustrating definition of samples used by PDPC applied to an adjacent diagonal bottom-left mode;

FIG. 12 is a schematic diagram illustrating gradient approach for non-vertical/non-horizontal mode;

FIG. 13 is a schematic diagram illustrating nScale values with respect to nTbH and mode number; for all nScale<0 cases gradient approach is used;

FIG. 14 is a schematic diagram illustrating flowcharts of current PDPC and proposed PDPC;

FIG. 15 is a schematic diagram illustrating neighboring blocks (L, A, BL, AR, AL) used in the derivation of a general MPM list;

FIG. 16 is a schematic diagram illustrating an example on proposed intra reference mapping;

FIG. 17 is a schematic diagram illustrating an example of four reference lines neighboring to a prediction block;

FIG. 18A is a schematic diagram illustrating examples of sub-partitions for 4×8 and 8×4 CUs;

FIG. 18B is a schematic diagram illustrating examples of sub-partitions for CUs other than 4×8, 8×4 and 4×4;

FIG. 19 is a schematic diagram illustrating matrix weighted intra prediction process;

FIG. 20 is a schematic diagram illustrating target samples, template samples and the reference samples of template used in the DIMD;

FIG. 21 is a schematic diagram illustrating proposed intra block decoding process;

FIG. 22 is a schematic diagram illustrating HoG computation from a template of width 3 pixels;

FIG. 23 is a schematic diagram illustrating prediction fusion by weighted averaging of two HoG modes and planar;

FIGS. 24A-24J are schematic diagrams illustrating templates used in the derivation of IPM for chroma;

FIGS. 25A-25C are schematic diagrams illustrating reference samples of the template;

FIGS. 26A-26C are schematic diagrams illustrating reference samples of the template located at left and above of the template;

FIGS. 27A-27C are schematic diagrams illustrating partial or all of the reference samples of the template inside the template;

FIG. 28 illustrates a flowchart of a method for video processing in accordance with some embodiments of the present disclosure; and

FIG. 29 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

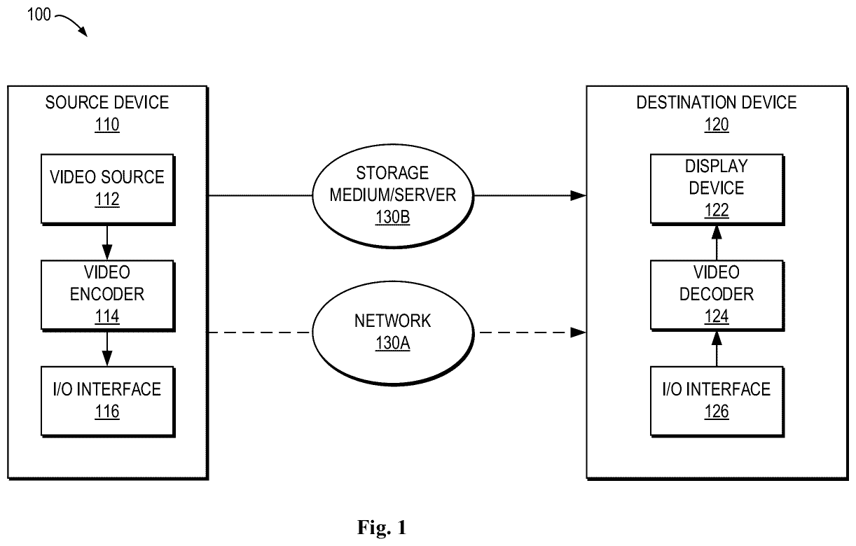

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

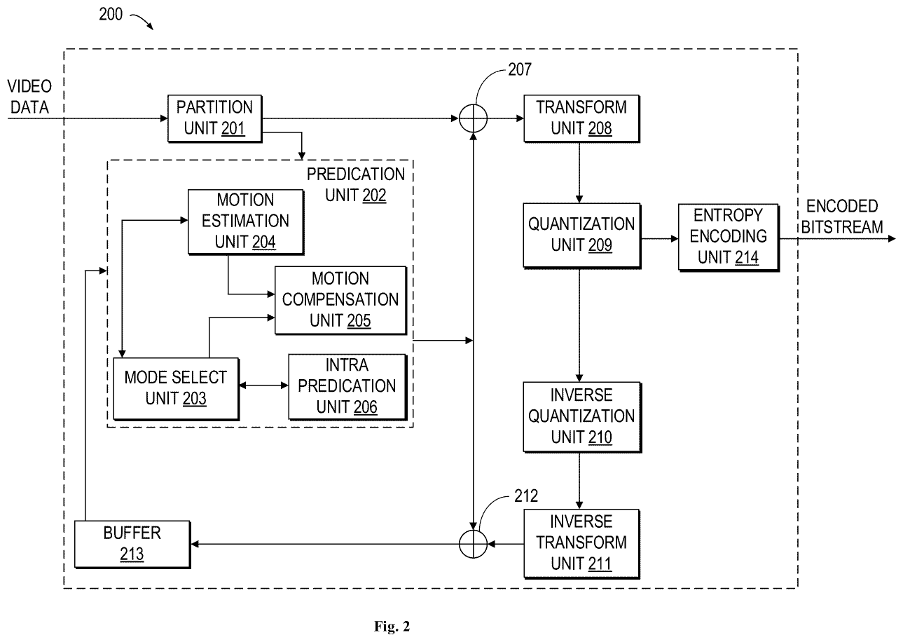

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the other video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

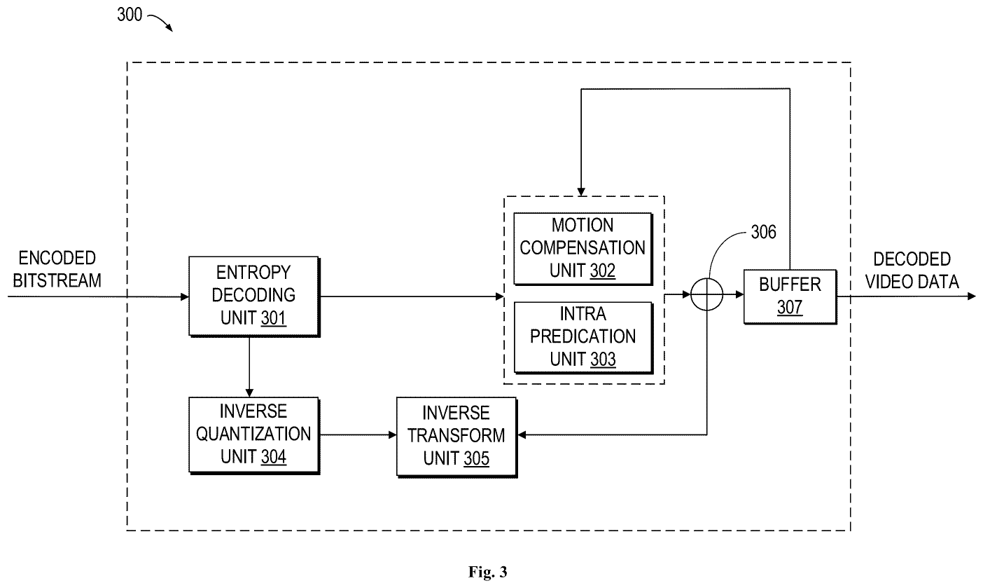

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate case of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1. SUMMARY

This disclosure is related to video coding technologies. Specifically, it is related a coding tool that derives mode of cross-component linear model or multi-model linear model for chroma components using previously decoded blocks, and a coding tool to derive the prediction/reconstruction of chroma components using samples of luma components, and other coding tools in image/video coding. It may be applied to the existing video coding standard like HEVC, or Versatile Video Coding (VVC). It may be also applicable to future video coding standards or video codec.

### 2. BACKGROUND

Video coding standards have evolved primarily through the development of the well-known ITU-T and ISO/IEC standards. The ITU-T produced H.261 and H.263, ISO/IEC produced MPEG-1 and MPEG-4 Visual, and the two organizations jointly produced the H.262/MPEG-2 Video and H.264/MPEG-4 Advanced Video Coding (AVC) and H.265/HEVC standards. Since H.262, the video coding standards are based on the hybrid video coding structure wherein temporal prediction plus transform coding are utilized. To explore the future video coding technologies beyond HEVC, Joint Video Exploration Team (JVET) was founded by VCEG and MPEG jointly in 2015. Since then, many new methods have been adopted by JVET and put into the reference software named Joint Exploration Model (JEM). In April 2018, the Joint Video Expert Team (JVET) between VCEG (Q6/16) and ISO/IEC JTC1 SC29/WG11 (MPEG) was created to work on the VVC standard targeting at 50% bitrate reduction compared to HEVC.

### 2.1. Color Space and Chroma Subsampling

Color space, also known as the color model (or color system), is an abstract mathematical model which simply describes the range of colors as tuples of numbers, typically as 3 or 4 values or color components (e.g., RGB). Basically speaking, color space is an elaboration of the coordinate system and sub-space.

For video compression, the most frequently used color spaces are YCbCr and RGB. YCbCr, Y′CbCr, or Y Pb/Cb Pr/Cr, also written as YCBCR or Y′CBCR, is a family of color spaces used as a part of the color image pipeline in video and digital photography systems. Y′ is the luma component and CB and CR are the blue-difference and red-difference chroma components. Y′ (with prime) is distinguished from Y, which is luminance, meaning that light intensity is nonlinearly encoded based on gamma corrected RGB primaries.

Chroma subsampling is the practice of encoding images by implementing less resolution for chroma information than for luma information, taking advantage of the human visual system's lower acuity for color differences than for luminance.

2.1.1. 4:4:4

Each of the three Y′CbCr components have the same sample rate, thus there is no chroma subsampling. This scheme is sometimes used in high-end film scanners and cinematic post production.

2.1.2. 4:2:2

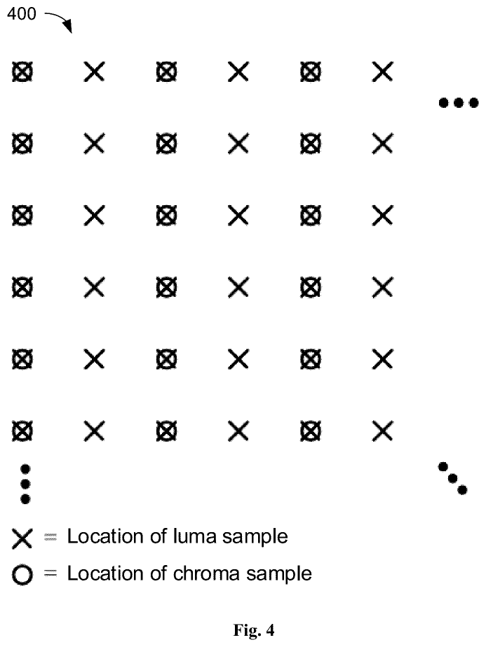

The two chroma components are sampled at half the sample rate of luma: the horizontal chroma resolution is halved while the vertical chroma resolution is unchanged. This reduces the bandwidth of an uncompressed video signal by one-third with little to no visual difference. An example of nominal vertical and horizontal locations of 4:2:2 color format is depicted in FIG. 4 in VVC working draft. FIG. 4 is a schematic diagram 400 illustrating nominal vertical and horizontal locations of 4:2:2 luma and chroma samples in a picture.

2.1.3. 4:2:0

In 4:2:0, the horizontal sampling is doubled compared to 4:1:1, but as the Cb and Cr channels are only sampled on each alternate line in this scheme, the vertical resolution is halved. The data rate is thus the same. Cb and Cr are each subsampled at a factor of 2 both horizontally and vertically. There are three variants of 4:2:0 schemes, having different horizontal and vertical siting.
In MPEG-2, Cb and Cr are cosited horizontally. Cb and Cr are sited between pixels in the vertical direction (sited interstitially).
In JPEG/JFIF, H.261, and MPEG-1, Cb and Cr are sited interstitially, halfway between alternate luma samples.
In 4:2:0 DV, Cb and Cr are co-sited in the horizontal direction. In the vertical direction, they are co-sited on alternating lines.

TABLE 2-1
SubWidthC and SubHeightC values derived from
chroma_format_idc and separate_colour_plane_flag
•

| chroma_for- | separate_col- | Chroma | | |
|---|---|---|---|---|
| mat_idc | our_plane_flag | format | SubWidthC | SubHeightC |
| 0 | 0 | Mono- | 1 | 1 |
| | | chrome | | |
| 1 | 0 | 4:2:0 | 2 | 2 |
| 2 | 0 | 4:2:2 | 2 | 1 |
| 3 | 0 | 4:4:4 | 1 | 1 |
| 3 | 1 | 4:4:4 | 1 | 1 |

### 2.2. Coding Flow of a Typical Video Codec

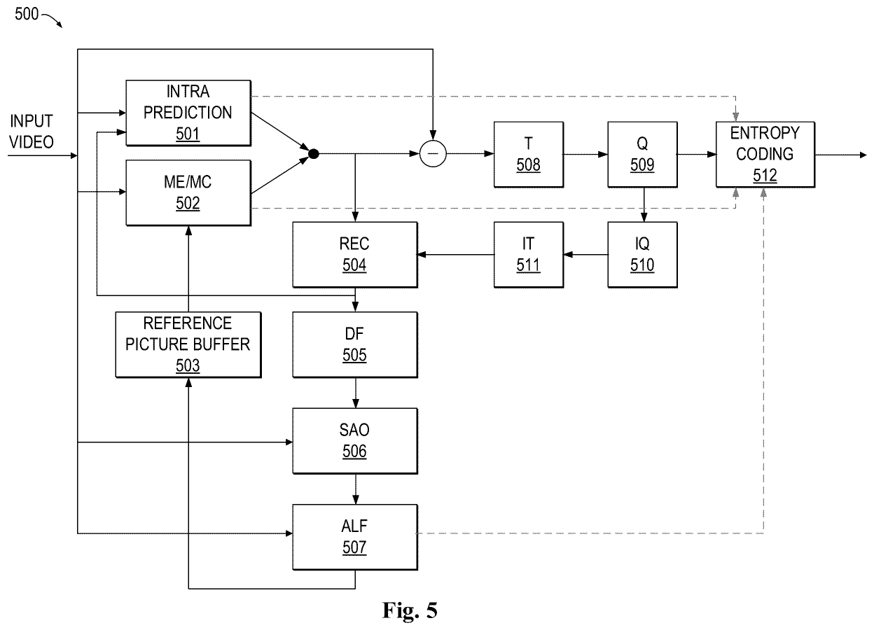

FIG. 5 is a schematic diagram 500 illustrating example of encoder block diagram. FIG. 5 shows an example of encoder block diagram of VVC, which contains three in-loop filtering blocks: deblocking filter (DF), sample adaptive offset (SAO) and ALF. Unlike DF, which uses predefined filters, SAO and ALF utilize the original samples of the current picture to reduce the mean square errors between the original samples and the reconstructed samples by adding an offset and by applying a finite impulse response (FIR) filter, respectively, with coded side information signalling the offsets and filter coefficients. ALF is located at the last processing stage of each picture and can be regarded as a tool trying to catch and fix artifacts created by the previous stages.

2.3. Intra Mode Coding with 67 Intra Prediction Modes

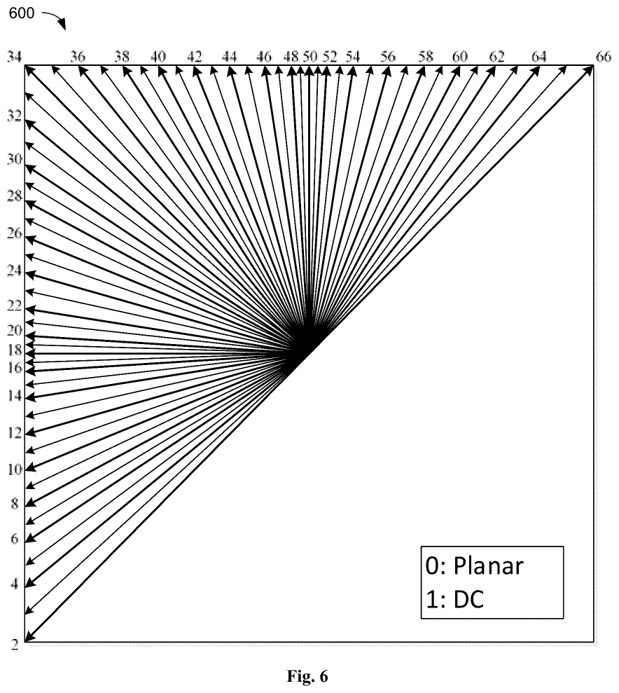

To capture the arbitrary edge directions presented in natural video, the number of directional intra modes is extended from 33, as used in HEVC, to 65, as shown in FIG. 6, and the planar and DC modes remain the same. FIG. 6 is a schematic diagram 600 illustrating 67 intra prediction modes. These denser directional intra prediction modes apply for all block sizes and for both luma and chroma intra predictions.

In the HEVC, every intra-coded block has a square shape and the length of each of its side is a power of 2. Thus, no division operations are required to generate an intra-predictor using DC mode. In VVC, blocks can have a rectangular shape that necessitates the use of a division operation per block in the general case. To avoid division operations for DC prediction, only the longer side is used to compute the average for non-square blocks.

### 2.3.1. Wide Angle Intra Prediction

Although 67 modes are defined in the VVC, the exact prediction direction for a given intra prediction mode index is further dependent on the block shape. Conventional angular intra prediction directions are defined from 45 degrees to −135 degrees in clockwise direction. In VVC, several conventional angular intra prediction modes are adaptively replaced with wide-angle intra prediction modes for non-square blocks. The replaced modes are signalled using the original mode indexes, which are remapped to the indexes of wide angular modes after parsing. The total number of intra prediction modes is unchanged, i.e., 67, and the intra mode coding method is unchanged.

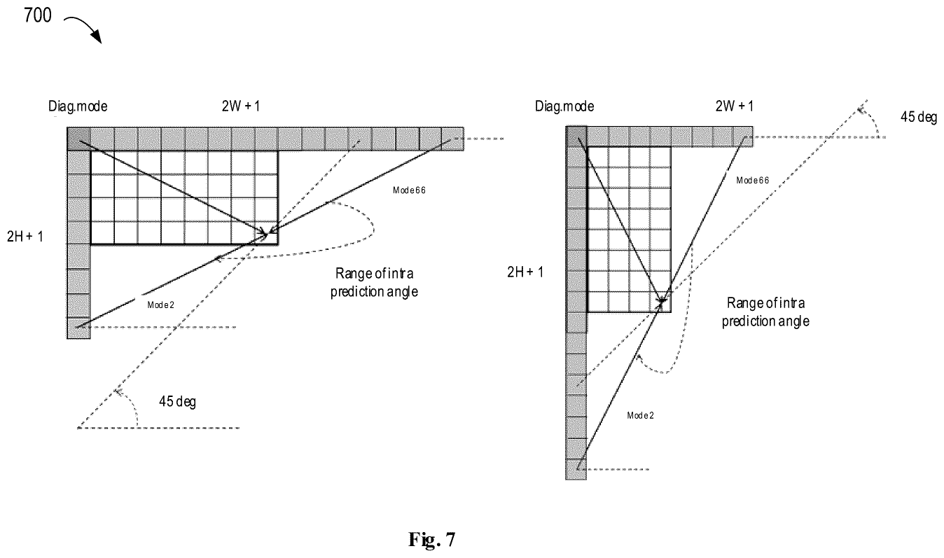

To support these prediction directions, the top reference with length 2W+1, and the left reference with length 2H+1, are defined as shown in FIG. 7. FIG. 7 is a schematic diagram 700 illustrating reference samples for wide-angular intra prediction.

The number of replaced modes in wide-angular direction mode depends on the aspect ratio of a block. The replaced intra prediction modes are illustrated in Table 2-2

TABLE 2-2
Intra prediction modes replaced by wide-angular modes

| Aspect ratio | Replaced intra prediction modes |
|---|---|
| W/H == 16 | Modes 2, 3, 4, 5, 6, 7, 8, 9, 10, 11, 12, 13, 14, 15 |
| W/H == 8 | Modes 2, 3, 4, 5, 6, 7, 8, 9, 10, 11, 12, 13 |
| W/H == 4 | Modes 2, 3, 4, 5, 6, 7, 8, 9, 10, 11 |
| W/H == 2 | Modes 2, 3, 4, 5, 6, 7, 8, 9 |
| W/H == 1 | None |
| W/H == ½ | Modes 59, 60, 61, 62, 63, 64, 65, 66 |
| W/H == ¼ | Mode 57, 58, 59, 60, 61, 62, 63, 64, 65, 66 |
| W/H == ⅛ | Modes 55, 56, 57, 58, 59, 60, 61, 62, 63, 64, 65, 66 |
| W/H == 1/16 | Modes 53, 54, 55, 56, 57, 58, 59, 60, 61, 62, 63, 64, 65, |
| | 66 |

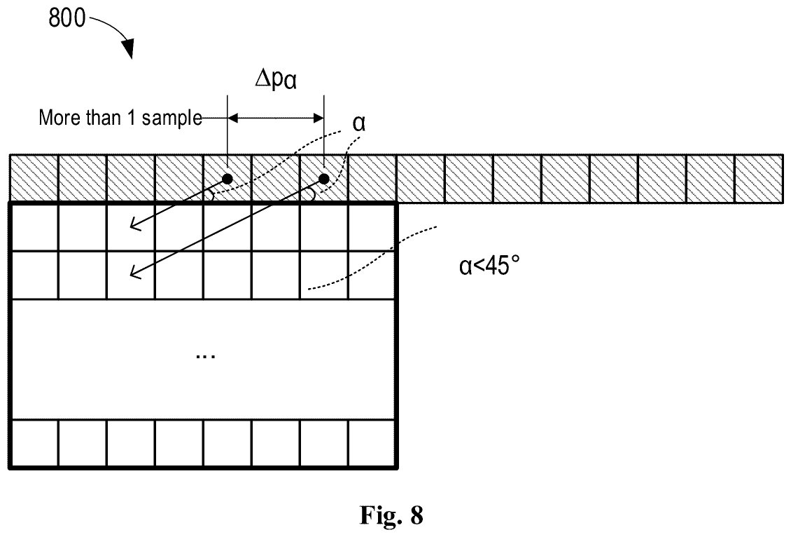

FIG. 8 is a schematic diagram 800 illustrating problem of discontinuity in case of directions beyond 45°. As shown in FIG. 8, two vertically adjacent predicted samples may use two non-adjacent reference samples in the case of wide-angle intra prediction. Hence, low-pass reference samples filter and side smoothing are applied to the wide-angle prediction to reduce the negative effect of the increased gap Δp_{α}. If a wide-angle mode represents a non-fractional offset. There are 8 modes in the wide-angle modes satisfy this condition, which are [−14, −12, −10, −6, 72, 76, 78, 80]. When a block is predicted by these modes, the samples in the reference buffer are directly copied without applying any interpolation. With this modification, the number of samples needed to be smoothing is reduced.

Besides, it aligns the design of non-fractional modes in the conventional prediction modes and wide-angle modes.

In VVC, 4:2:2 and 4:4:4 chroma formats are supported as well as 4:2:0. Chroma derived mode (DM) derivation table for 4:2:2 chroma format was initially ported from HEVC extending the number of entries from 35 to 67 to align with the extension of intra prediction modes. Since HEVC specification does not support prediction angle below −135 degree and above 45 degree, luma intra prediction modes ranging from 2 to 5 are mapped to 2. Therefore, chroma DM derivation table for 4:2:2: chroma format is updated by replacing some values of the entries of the mapping table to convert prediction angle more precisely for chroma blocks.

### 2.4. Intra Prediction Mode Coding for Chroma Component

For the chroma component of an intra PU, the encoder selects the best chroma prediction modes among five modes including Planar, DC, Horizontal, Vertical and a direct copy of the intra prediction mode for the luma component. The mapping between intra prediction direction and intra prediction mode number for chroma is shown in Table 2-3.

When the intra prediction mode number for the chroma component is 4, the intra prediction direction for the luma component is used for the intra prediction sample generation for the chroma component. When the intra prediction mode number for the chroma component is not 4 and it is identical to the intra prediction mode number for the luma component, the intra prediction direction of 66 is used for the intra prediction sample generation for the chroma component.

### 2.5. Inter Prediction

For each inter-predicted CU, motion parameters consisting of motion vectors, reference picture indices and reference picture list usage index, and additional information needed for the new coding feature of VVC to be used for inter-predicted sample generation. The motion parameter can be signalled in an explicit or implicit manner. When a CU is coded with skip mode, the CU is associated with one PU and has no significant residual coefficients, no coded motion vector delta or reference picture index.

A merge mode is specified whereby the motion parameters for the current CU are obtained from neighbouring CUs, including spatial and temporal candidates, and additional schedules introduced in VVC. The merge mode can be applied to any inter-predicted CU, not only for skip mode. The alternative to merge mode is the explicit transmission of motion parameters, where motion vector, corresponding reference picture index for each reference picture list and reference picture list usage flag and other needed information are signalled explicitly per each CU.

### 2.6. Intra Block Copy (IBC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 sub-blocks. For the current block of a larger size, a hash key is determined to match that of the reference block when all the hash keys of all 4×4 sub-blocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs. At CU level, IBC mode is signalled with a flag and it can be signalled as IBC AMVP mode or IBC skip/merge mode as follows:
IBC skip/merge mode: a merge candidate index is used to indicate which of the block vectors in the list from neighbouring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbour and one from above neighbour (if IBC coded). When either neighbour is not available, a default block vector will be used as a predictor. A flag is signalled to indicate the block vector predictor index.

### 2.7. Cross-Component Linear Model Prediction

To reduce the cross-component redundancy, a cross-component linear model (CCLM) prediction mode is used in the VVC, for which the chroma samples are predicted based on the reconstructed luma samples of the same CU by using a linear model as follows:

pred_{C}(i,j)=α·rec_{L}′(i,j)+β (2-1)

where pred_{C}(i, j) represents the predicted chroma samples in a CU and rec_{L}(i, j) represents the down-sampled reconstructed luma samples of the same CU.

The CCLM parameters (a and B) are derived with at most four neighbouring chroma samples and their corresponding down-sampled luma samples. Suppose the current chroma block dimensions are W×H, then W″ and H′ are set as
W′=W, H′=H when LM mode is applied;
W′=W+H when LM_T mode is applied;
H′=H+W when LM_L mode is applied;

### Min-Max Method to Derive the Parameters of CCLM

The above neighbouring positions are denoted as S[0, −1] . . . S[W′−1, −1] and the left neighbouring positions are denoted as S[−1, 0] . . . S[−1, H′−1]. Then the four samples are selected as
S[W′/4, −1], S[3*W′/4, −1], S[−1, H′/4], S[−1, 3*H′/4] when LM mode is applied and both above and left neighbouring samples are available;
S[W′/8, −1], S[3*W′/8, −1], S[5*W′/8, −1], S[7*W′/8, −1] when LM_T mode is applied or only the above neighbouring samples are available;
S[−1, H′/8], S[−1, 3*H′/8], S[−1, 5*H′/8], S[−1, 7*H′/8] when LM_L mode is applied or only the left neighbouring samples are available;

The four neighbouring luma samples at the selected positions are downsampled and compared four times to find two larger values: x⁰_{A} and x¹_{A}, and two smaller values: x⁰_{B} and x¹_{B}. Their corresponding chroma sample values are denoted as y⁰_{A}, y¹_{A}, y⁰_{B} and y¹_{B}. Then X_{A}, X_{B}, y_{A} and y_{B} are derived as:

Xₐ=(x⁰_{A}+x¹_{A}+1)>>1;X_{b}=(x⁰_{B}+x¹_{B}+1)>>1;Yₐ=(y⁰_{A}+y¹_{A}+1)>>1;Y_{b}=(y⁰_{B}+y¹_{B}+1)>>1 (2-2)

Finally, the linear model parameters α and β are obtained according to the following equations.

$$\\ \begin{matrix}α = \frac{{Y}_{a} - {Y}_{b}}{{X}_{a} - {X}_{b}} & ( 2 ‐ 3 )\end{matrix}$$

$$\\ \begin{matrix}β = {Y}_{b} - α \cdot {X}_{b} & ( 2 ‐ 4 )\end{matrix}$$

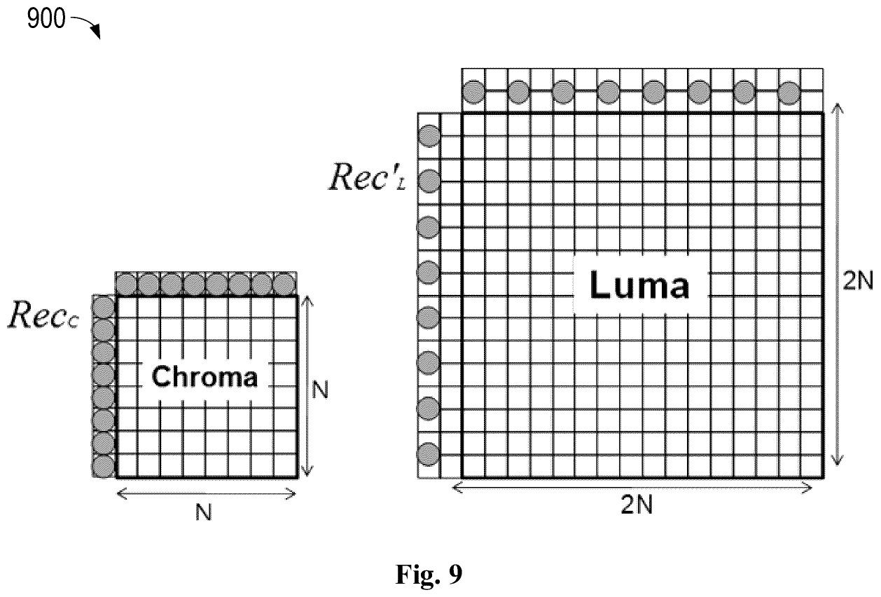

FIG. 9 is a schematic diagram 900 illustrating locations of the samples used for the derivation of α and β. FIG. 9 shows an example of the location of the left and above samples and the sample of the current block involved in the CCLM mode.

The division operation to calculate parameter a is implemented with a look-up table. To reduce the memory required for storing the table, the diff value (difference between maximum and minimum values) and the parameter a are expressed by an exponential notation. For example, diff is approximated with a 4-bit significant part and an exponent. Consequently, the table for 1/diff is reduced into 16 elements for 16 values of the significand as follows:

DivTable[ ]={0, 7, 6, 5, 5, 4, 4, 3, 3, 2, 2, 1, 1, 1, 1, 0} (2-5)

This would have a benefit of both reducing the complexity of the calculation as well as the memory size required for storing the needed tables

Besides the above template and left template can be used to calculate the linear model coefficients together, they also can be used alternatively in the other 2 LM modes, called LM_T, and LM_L modes. In LM_T mode, only the above template is used to calculate the linear model coefficients. To get more samples, the above template is extended to (W+H) samples. In LM_L mode, only left template is used to calculate the linear model coefficients. To get more samples, the left template is extended to (H+W) samples.

In LM mode, left and above templates are used to calculate the linear model coefficients.

To match the chroma sample locations for 4:2:0 video sequences, two types of down-sampling filter are applied to luma samples to achieve 2 to 1 down-sampling ratio in both horizontal and vertical directions. The selection of down-sampling filter is specified by a SPS level flag. The two down-sampling filters are as follows, which are corresponding to “type-0” and “type-2” content, respectively.

$$\\ \begin{matrix}{Rec}_{L}^{{}_{} ′} ( i , j ) = [ \begin{matrix}{rec}_{L} ( 2 i - 1 , 2 j - 1 ) + 2 \cdot {rec}_{L} ( 2 i - 1 , 2 j - 1 ) + \\ {rec}_{L} ( 2 i + 1 , 2 j - 1 ) + {rec}_{L} ( 2 i - 1 , 2 j ) + 2 \cdot {rec}_{L} ( 2 i , 2 j ) + \\ {rec}_{L} ( 2 i + 1 , 2 j ) + 4\end{matrix} ] ≫ 3 & ( 2 ‐ 6 )\end{matrix}$$

$$\\ \begin{matrix}{rec}_{L}^{{}_{} ′} ( i , j ) = [ \begin{matrix}{rec}_{L} ( 2 i , 2 j - 1 ) + {rec}_{L} ( 2 i - 1 , 2 j ) + 4 \cdot {rec}_{L} ( 2 i , 2 j ) + \\ {rec}_{L} ( 2 i + 1 , 2 j ) + {rec}_{L} ( 2 i , 2 j + 1 ) + 4\end{matrix} ] ≫ 3 & ( 2 ‐ 7 )\end{matrix}$$

Note that only one luma line (general line buffer in intra prediction) is used to make the down-sampled luma samples when the upper reference line is at the CTU boundary.

This parameter computation is performed as part of the decoding process, and is not just as an encoder search operation. As a result, no syntax is used to convey the α and β values to the decoder.

For chroma intra mode coding, a total of 8 intra modes are allowed for chroma intra mode coding. Those modes include five conventional intra modes and three cross-component linear model modes (LM, LM_T, and LM_L). Chroma mode signalling and derivation process are shown in Table 2-3. Chroma mode coding directly depends on the intra prediction mode of the corresponding luma block. Since separate block partitioning structure for luma and chroma components is enabled in I slices, one chroma block may correspond to multiple luma blocks. Therefore, for Chroma DM mode, the intra prediction mode of the corresponding luma block covering the center position of the current chroma block is directly inherited.

TABLE 2-3
Derivation of chroma prediction mode
from luma mode when CCLM is enabled

| Chroma | Corresponding luma intra prediction mode | | | | |
|---|---|---|---|---|---|
| prediction mode | 0 | 50 | 18 | 1 | X ( 0 <= X <= 66 ) |
| 0 | 66 | 0 | 0 | 0 | 0 |
| 1 | 50 | 66 | 50 | 50 | 50 |
| 2 | 18 | 18 | 66 | 18 | 18 |
| 3 | 1 | 1 | 1 | 66 | 1 |
| 4 | 0 | 50 | 18 | 1 | X |
| 5 | 81 | 81 | 81 | 81 | 81 |
| 6 | 82 | 82 | 82 | 82 | 82 |
| 7 | 83 | 83 | 83 | 83 | 83 |

A single binarization table is used regardless of the value of sps_cclm_enabled_flag as shown in Table 2-4.

TABLE 2-4
Unified binarization table for chroma prediction mode

| Value of | |
|---|---|
| intra_chroma_pred_mode | Bin string |
| 4 | 00 |
| 0 | 0100 |
| 1 | 0101 |
| 2 | 0110 |
| 3 | 0111 |
| 5 | 10 |
| 6 | 110 |
| 7 | 111 |

In Table 2-4, the first bin indicates whether it is regular (0) or LM modes (1). If it is LM mode, then the next bin indicates whether it is LM_CHROMA (0) or not. If it is not LM_CHROMA, next 1 bin indicates whether it is LM_L (0) or LM_T (1). For this case, when sps_cclm_enabled_flag is 0, the first bin of the binarization table for the corresponding intra_chroma_pred_mode can be discarded prior to the entropy coding. Or, in other words, the first bin is inferred to be 0 and hence not coded. This single binarization table is used for both sps_cclm_enabled_flag equal to 0 and 1 cases. The first two bins in Table 2-4 are context coded with its own context model, and the rest bins are bypass coded. In addition, in order to reduce luma-chroma latency in dual tree, when the 64×64 luma coding tree node is partitioned with Not Split (and ISP is not used for the 64×64 CU) or QT, the chroma CUs in 32×32/32×16 chroma coding tree node is allowed to use CCLM in the following way:
If the 32×32 chroma node is not split or partitioned QT split, all chroma CUs in the 32×32 node can use CCLM
If the 32×32 chroma node is partitioned with Horizontal BT, and the 32×16 child node does not split or uses Vertical BT split, all chroma CUs in the 32×16 chroma node can use CCLM.

In all the other luma and chroma coding tree split conditions, CCLM is not allowed for chroma CU.

### 2.8. Multi-Model Linear Model (MMLM)

With MMLM, there can be more than one linear model between the luma samples and chroma samples in a CU. In this method, neighboring luma samples and neighboring chroma samples of the current block are classified into several groups, each group is used as a training set to derive a linear model (i.e., particular α and β are derived for a particular group). Furthermore, the samples of the current luma block are also classified based on the same rule for the classification of neighboring luma samples. The neighboring samples can be classified into M groups, where M is 2 or 3. The MMLM method with M=2 and M=3 are designed as two appended Chroma prediction modes named MMLM2 and MMLM3, besides the original LM mode. The encoder chooses the optimal mode in the RDO process and signal the mode.

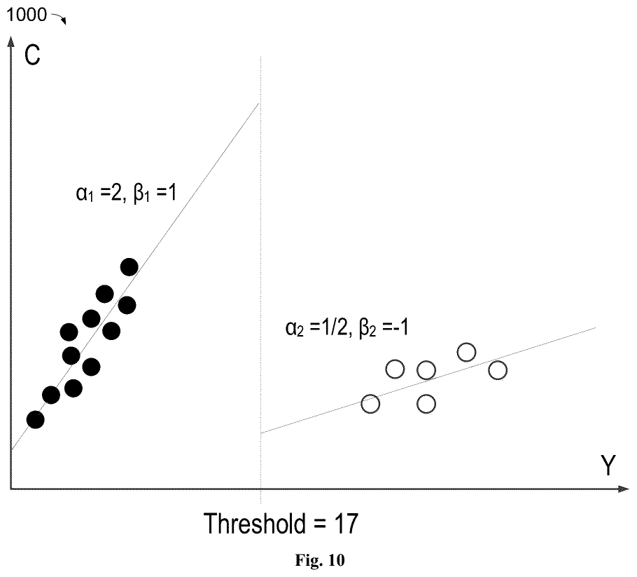

When M is equal to 2, FIG. 10 shows an example of classifying the neighboring samples into two groups. Threshold is calculated as the average value of the neighboring reconstructed Luma samples.

A neighboring sample with Rec′L[x,y]<=Threshold Rec′_{L}[x, y]≤Threshold is classified into group 1; while a neighboring sample with Rec′_{L}[x,y]>Threshold Rec′L[x,y]>Threshold is classified into group 2. Similar to CCLM, there are 3 modes in MMLM, namely MMLM, MMLM_T, and MMLM_L. Two models are derived as

$$\{ \begin{matrix}\begin{matrix}Pre {d}_{C} [ x , y ] = \\ {α}_{1} \times {Rec}_{L}^{′} [ x , y ] + {β}_{1}\end{matrix} & if {Rec}_{L}^{′} [ x , y ] \leq Threshold \\ \begin{matrix}Pre {d}_{C} [ x , y ] = \\ {α}_{2} \times {Rec}_{L}^{′} [ x , y ] + {β}_{2}\end{matrix} & if {Rec}_{L}^{′} [ x , y ] > Threshold\end{matrix} \qquad ( 2 - 8 )$$

The threshold which is the average of the luma reconstructed neighboring samples. The linear model of each class is derived by using the Least-Mean-Square (LMS) method, if enabled, or min/max method of VVC.

### Least-Mean-Square (LMS) Method to Derive the Parameters of CCLM and MMLM

The CCLM or MMLM method utilizes linear least square solution between reconstructed data of down-sampled luma samples and chroma samples to derive model parameters α and β.

$$α = \frac{I \times {\sum }_{i = 0}^{I} R e {c}_{C} ( i ) \times {Rec}_{L}^{′} ( i ) - {\sum }_{i = 0}^{I} {Rec}_{C} ( i ) \times {\sum }_{i = 0}^{I} {Rec}_{L}^{′} ( i )}{I \times {\sum }_{i = 0}^{I} {Rec}_{L}^{′} ( i ) \times {Rec}_{L}^{′} ( i ) - {( {\sum }_{i = 0}^{I} {Rec}_{L}^{′} ( i ) )}^{2}} = \frac{{A}_{1}}{{A}_{2}} \qquad ( 2 - 9 )$$

$$β = \frac{{\sum }_{i = 0}^{I} {Rec}_{C} ( i ) - α \times {\sum }_{i = 0}^{I} {Rec}_{L}^{′} ( i )}{I} \qquad ( 2 - 10 )$$

Where Rec_{C}(i) and Rec′_{L}(i) indicate reconstructed chroma samples and down-sampled luma samples around the target block, I indicates total samples number of neighboring data.
2.9. Position dependent intra prediction combination

In VVC, the results of intra prediction of DC, planar and several angular modes are further modified by a position dependent intra prediction combination (PDPC) method. PDPC is an intra prediction method which invokes a combination of the boundary reference samples and HEVC style intra prediction with filtered boundary reference samples. PDPC is applied to the following intra modes without signalling: planar, DC, intra angles less than or equal to horizontal, and intra angles greater than or equal to vertical and less than or equal to 80. If the current block is BDPCM mode or MRL index is larger than 0, PDPC is not applied.

The prediction sample pred(x′,y′) is predicted using an intra prediction mode (DC, planar, angular) and a linear combination of reference samples according to the Equation 2-8 as follows:

pred(x′,y′)=Clip(0,(1<<BitDepth)−1,(wL×R_{-1,y′}+wT×R_{x′,-1}+(64−wL−wT)×pred(x′,y′)+32)>>6) (2-11)

where R_{x,-1}, R_{-1,y} represent the reference samples located at the top and left boundaries of current sample (x, y), respectively.

If PDPC is applied to DC, planar, horizontal, and vertical intra modes, additional boundary filters are not needed, as required in the case of HEVC DC mode boundary filter or horizontal/vertical mode edge filters. PDPC process for DC and Planar modes is identical. For angular modes, if the current angular mode is HOR_IDX or VER_IDX, left or top reference samples is not used, respectively. The PDPC weights and scale factors are dependent on prediction modes and the block sizes. PDPC is applied to the block with both width and height greater than or equal to 4.

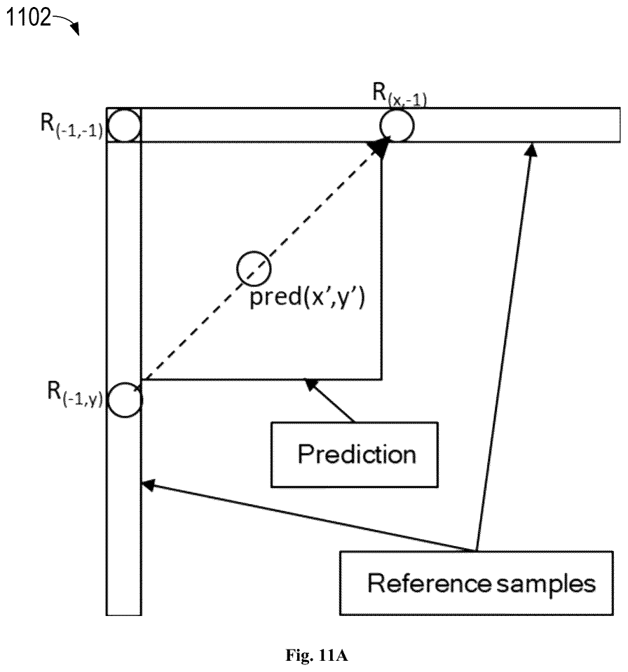

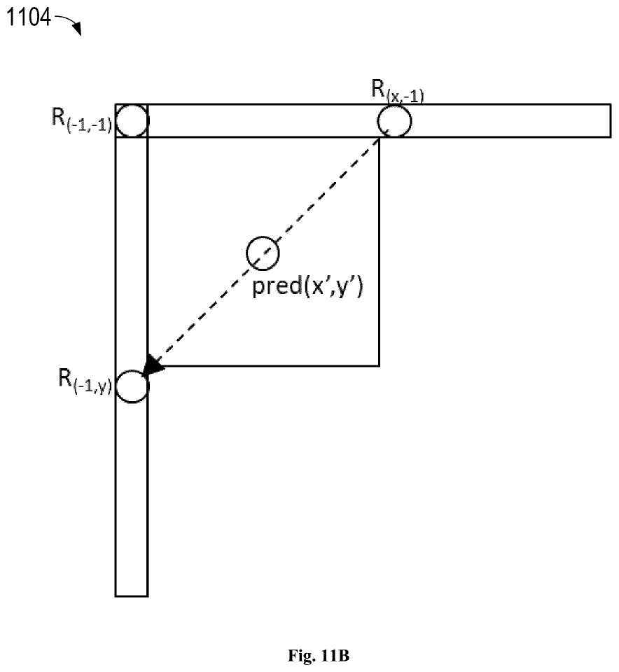

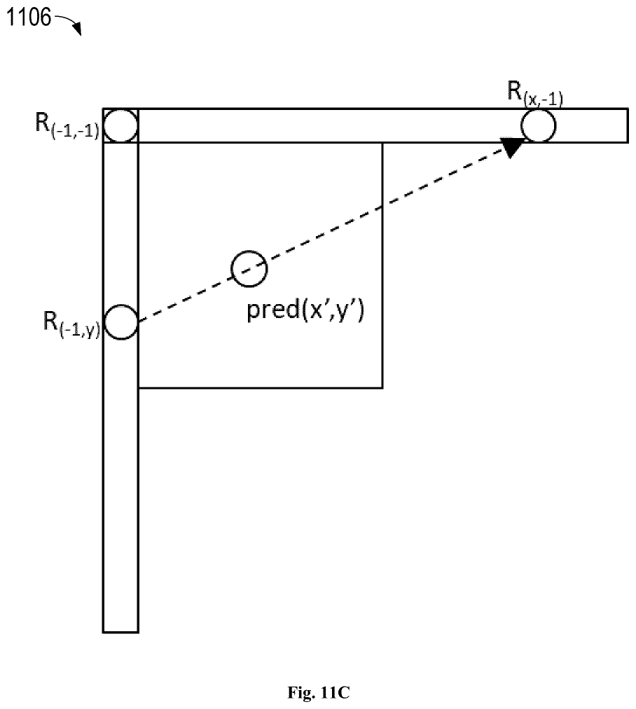

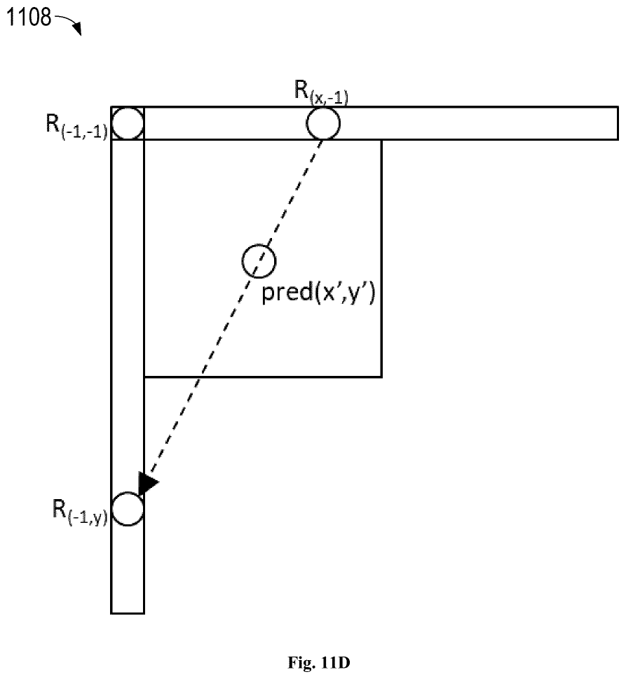

FIGS. 11A-11D illustrate the definition of reference samples (R_{x,-1} and R_{-1,y}) for PDPC applied over various prediction modes. FIG. 11A is a schematic diagram 1102 illustrating definition of samples used by PDPC applied to a diagonal top-right mode. FIG. 11B is a schematic diagram 1104 illustrating definition of samples used by PDPC applied to a diagonal bottom-left mode. FIG. 11C is a schematic diagram 1106 illustrating definition of samples used by PDPC applied to an adjacent diagonal top-right mode. FIG. 11D is a schematic diagram 1108 illustrating definition of samples used by PDPC applied to an adjacent diagonal bottom-left mode. The prediction sample pred(x′, y′) is located at (x′, y′) within the prediction block. As an example, the coordinate x of the reference sample R_{x,-1} is given by: x=x′+y′+1, and the coordinate y of the reference sample R_{-1,y} is similarly given by: y=x′+y′+1 for the diagonal modes. For the other angular mode, the reference samples R_{x,-1} and R_{-1,y} could be located in fractional sample position. In this case, the sample value of the nearest integer sample location is used.

### 2.10. Gradient PDPC

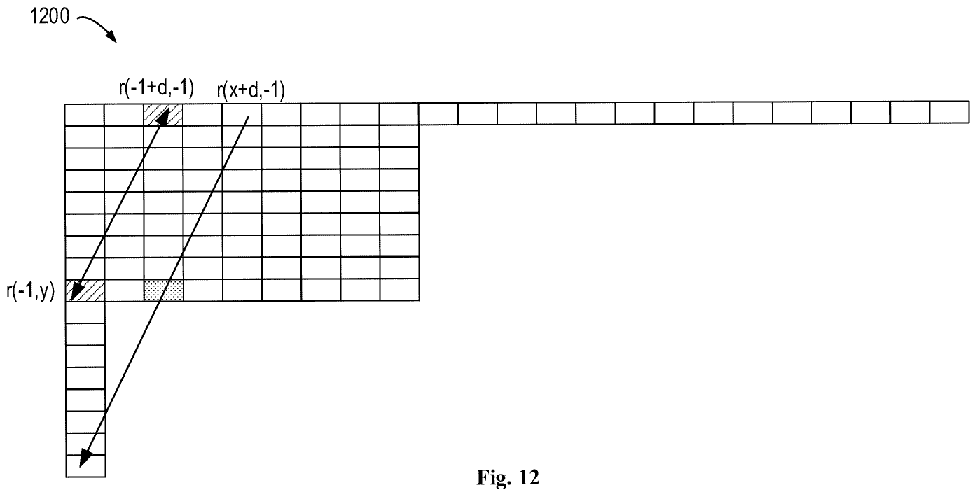

FIG. 12 is a schematic diagram 1200 illustrating gradient approach for non-vertical/non-horizontal mode. The gradient based approach is extended for non-vertical/non-horizontal mode, as shown in FIG. 12. Here, the gradient is computed as r(−1, y)−r(−1+d, −1), where d is the horizontal displacement depending on the angular direction. A few points to note here:

The gradient term r(−1, y)−r(−1+d, −1) is needed to be computed once for every row, as it does not depend on the x position.

The computation of d is already part of original intra prediction process which can be reused, so a separate computation of d is not needed. Accordingly, d is in 1/32 pixel accuracy

Two tap (linear) filtering is used when d is at fractional position, i.e., if dPos is the displacement in 1/32 pixel accuracy, dInt is the (floored) integer part (dPos>>5), and dFract is the fractional part in 1/32 pixel accuracy (dPos & 31), then r(−1+d) is computed as:

r(−1+d)=(32−dFrac)*r(−1+dInt)+dFrac*r(−1+dInt+1)

This 2 tap filtering is performed once per row (if needed), as explained in a.

Finally, the prediction signal is computed

p(x,y)=Clip(((64−wL(x))*p(x,y)+wL(x)*(r(−1,y)−r(−1+d,−1))+32)>>6)

Where wL(x)=32>>((x<<1)>>nScale2), and nScale2=(log 2(nTbH)+log 2(nTbW)−2)>>2, which are the same as vertical/horizontal mode. In a nutshell, the same process is applied compared to vertical/horizontal mode (in fact, d=0 indicates vertical/horizontal mode).

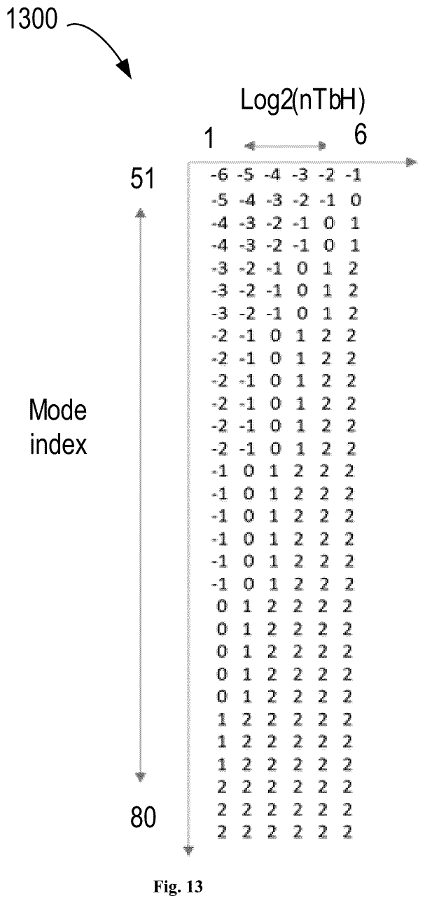

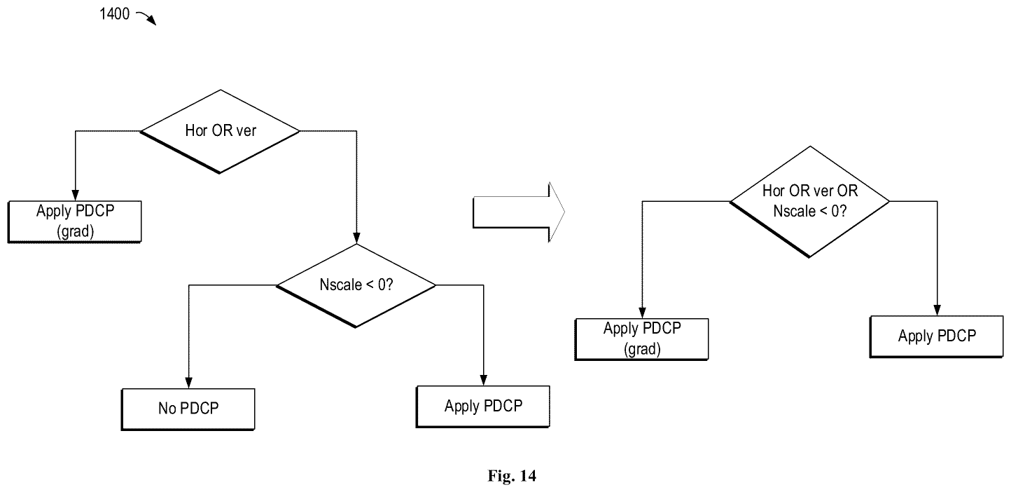

Second, the gradient based approach for non-vertical/non-horizontal mode is activated when (nScale<0) or when PDPC can't be applied due to unavailability of secondary reference sample. FIG. 13 is a schematic diagram 1300 illustrating nScale values with respect to nTbH and mode number; for all nScale<0 cases gradient approach is used. The values of nScale are shown in FIG. 13, with respect to TB size and angular mode, to better visualize the cases where gradient approach is used. Additionally, the flowchart for current PDPC (left) and proposed PDPC (right) are shown in FIG. 14.

### 2.11. Secondary MPM

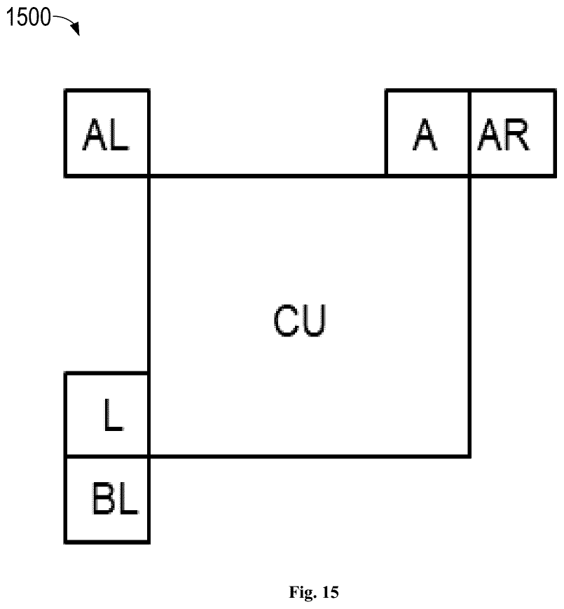

Secondary MPM lists is introduced as described in JVET-D0114. The existing primary MPM (PMPM) list consists of 6 entries and the secondary MPM (SMPM) list includes 16 entries. A general MPM list with 22 entries is constructed first, and then the first 6 entries in this general MPM list are included into the PMPM list, and the rest of entries form the SMPM list. The first entry in the general MPM list is the Planar mode. The remaining entries are composed of the intra modes of the left (L), above (A), below-left (BL), above-right (AR), and above-left (AL) neighbouring blocks as shown in FIG. 15, the directional modes with added offset from the first two available directional modes of neighbouring blocks, and the default modes.

If a CU block is vertically oriented, the order of neighbouring blocks is A, L, BL, AR, AL; otherwise, it is L, A, BL, AR, AL. FIG. 15 is a schematic diagram 1500 illustrating neighboring blocks (L, A, BL, AR, AL) used in the derivation of a general MPM list.

A PMPM flag is parsed first, if equal to 1 then a PMPM index is parsed to determine which entry of the PMPM list is selected, otherwise the SPMPM flag is parsed to determine whether to parse the SMPM index or the remaining modes.

### 2.12. 6-Tap Intra Interpolation Filter

To improve prediction accuracy, it is proposed to replace 4-tap Cubic interpolation filter with 6-tap interpolation filter, the filter coefficients are derived based on the same polynomial regression model, but with polynomial order of 6.

Filter coefficients are listed below,
{0, 0,256, 0, 0, 0}, // 0/32 position
{0, −4, 253, 9, −2, 0}, // 1/32 position
{1, −7, 249, 17, −4, 0}, // 2/32 position
{1,−10, 245, 25, −6, 1}, // 3/32 position
{1, −13, 241, 34, −8, 1}, // 4/32 position
{2, −16, 235, 44, −10, 1}, // 5/32 position
{2, −18, 229, 53, −12, 2}, // 6/32 position
{2, −20, 223, 63, −14, 2}, // 7/32 position
{2, −22, 217, 72, −15, 2}, // 8/32 position
{3, −23, 209, 82, −17, 2}, // 9/32 position
{3, −24, 202, 92, −19, 2}, // 10/32 position
{3, −25, 194, 101, −20, 3}, // 11/32 position
{3, −25, 185, 111, −21, 3}, // 12/32 position
{3, −26, 178, 121, −23, 3}, // 13/32 position
{3, −25, 168, 131, −24, 3}, // 14/32 position
{3, −25, 159, 141, −25, 3}, // 15/32 position
{3, −25, 150, 150, −25, 3}, //half-pel position

The reference samples used for interpolation come from reconstructed samples or padded as in HEVC, so that the conditional check on reference sample availability is not needed.

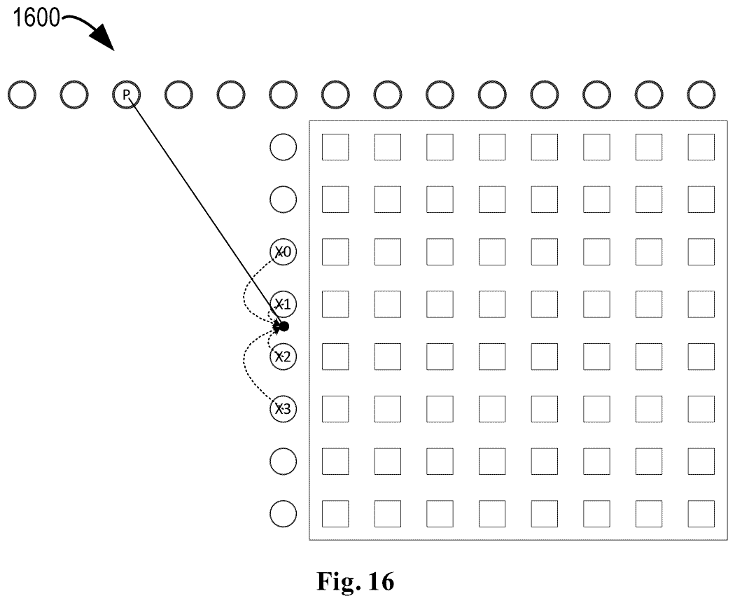

Instead of using nearest rounding operation to derive the extended Intra reference sample, it is proposed to use 4-tap Cubic interpolation filter. FIG. 16 is a schematic diagram 1600 illustrating an example on proposed intra reference mapping. As shown in an example in FIG. 16, to derive the value of reference sample P, a four tap interpolation filter is used, while in JEM-3.0 or HM, P is directly set as X1.

### 2.13. Multiple Reference Line (MRL) Intra Prediction

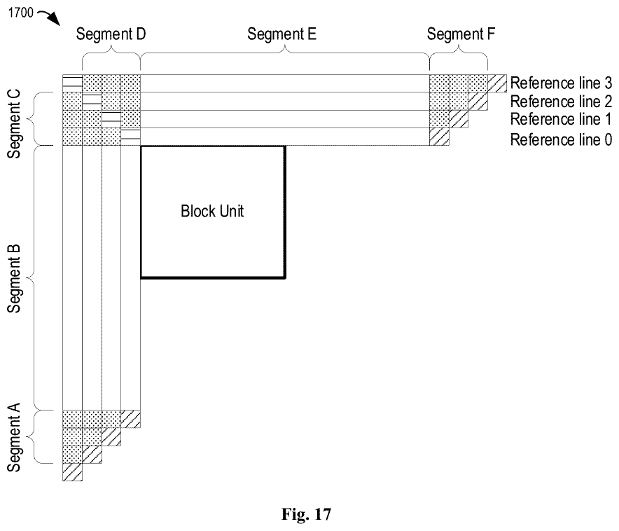

Multiple reference line (MRL) intra prediction uses more reference lines for intra prediction. FIG. 17 is a schematic diagram 1700 illustrating an example of four reference lines neighboring to a prediction block. In FIG. 17, an example of 4 reference lines is depicted, where the samples of segments A and F are not fetched from reconstructed neighbouring samples but padded with the closest samples from Segment B and E, respectively. HEVC intra-picture prediction uses the nearest reference line (i.e., reference line 0). In MRL, 2 additional lines (reference line 1 and reference line 2) are used.

The index of selected reference line (mrl_idx) is signalled and used to generate intra predictor. For reference line index, which is greater than 0, only include additional reference line modes in MPM list and only signal MPM index without remaining mode. The reference line index is signalled before intra prediction modes, and Planar mode is excluded from intra prediction modes in case a nonzero reference line index is signalled.

MRL is disabled for the first line of blocks inside a CTU to prevent using extended reference samples outside the current CTU line. Also, PDPC is disabled when additional line is used. For MRL mode, the derivation of DC value in DC intra prediction mode for non-zero reference line indices are aligned with that of reference line index 0. MRL requires the storage of 3 neighbouring luma reference lines with a CTU to generate predictions. The Cross-Component Linear Model (CCLM) tool also requires 3 neighbouring luma reference lines for its down-sampling filters. The definition of MRL to use the same 3 lines is aligned as CCLM to reduce the storage requirements for decoders.

### 2.14. Intra Sub-Partitions (ISP)

The intra sub-partitions (ISP) divides luma intra-predicted blocks vertically or horizontally into 2 or 4 sub-partitions depending on the block size. For example, minimum block size for ISP is 4×8 (or 8×4). If block size is greater than 4×8 (or 8×4) then the corresponding block is divided by 4 sub-partitions. It has been noted that the M×128 (with M≤64) and 128×N (with N≤64) ISP blocks could generate a potential issue with the 64×64 VDPU. For example, an M×128 CU in the single tree case has an M×128 luma TB and two corresponding

$$\\ \frac{M}{2} \times 64$$

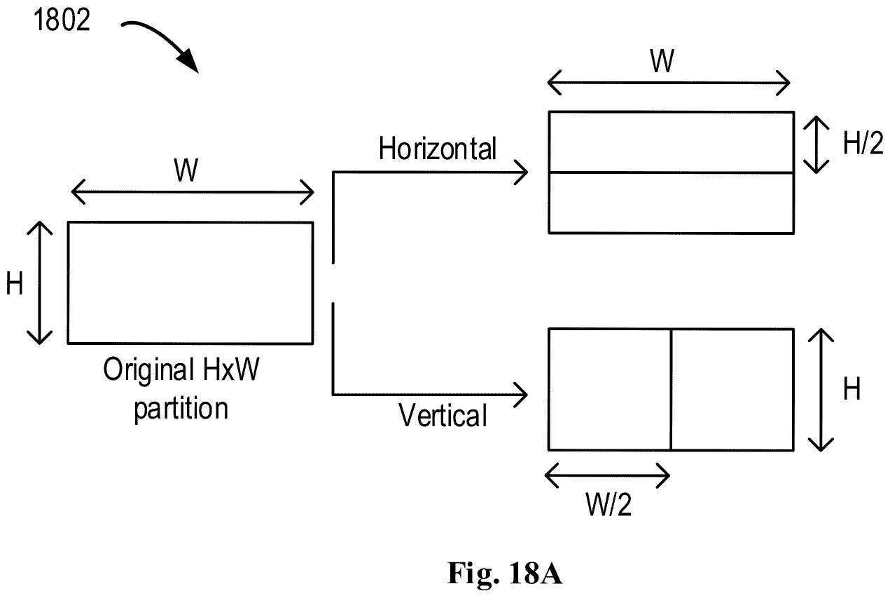

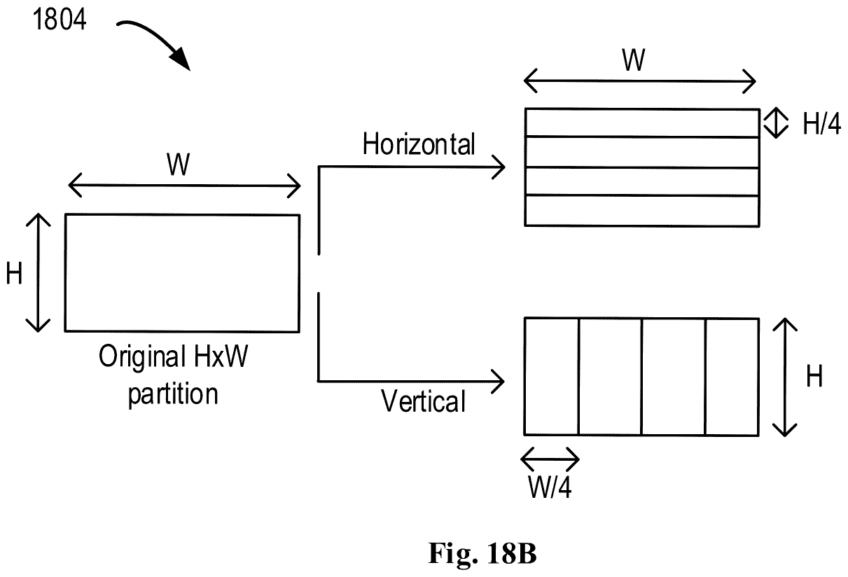

chroma TBs. It the CU uses ISP, then the luma TB will be divided into four M×32 TBs (only the horizontal split is possible), each of them smaller than a 64×64 block. However, in the current design of ISP chroma blocks are not divided. Therefore, both chroma components will have a size greater than a 32×32 block. Analogously, a similar situation could be created with a 128×N CU using ISP. Hence, these two cases are an issue for the 64×64 decoder pipeline. For this reason, the CU sizes that can use ISP is restricted to a maximum of 64×64. FIGS. 18A and 18B show examples of the two possibilities. FIG. 18A is a schematic diagram 1802 illustrating examples of sub-partitions for 4×8 and 8×4 CUs. FIG. 18B is a schematic diagram 1804 illustrating examples of sub-partitions for CUs other than 4×8, 8×4 and 4×4. All sub-partitions fulfill the condition of having at least 16 samples.

In ISP, the dependence of 1×N/2×N subblock prediction on the reconstructed values of previously decoded 1×N/2×N subblocks of the coding block is not allowed so that the minimum width of prediction for subblocks becomes four samples. For example, an 8×N (N>4) coding block that is coded using ISP with vertical split is split into two prediction regions each of size 4×N and four transforms of size 2×N. Also, a 4×N coding block that is coded using ISP with vertical split is predicted using the full 4×N block; four transform each of 1×N is used. Although the transform sizes of 1×N and 2×N are allowed, it is asserted that the transform of these blocks in 4×N regions can be performed in parallel. For example, when a 4×N prediction region contains four 1×N transforms, there is no transform in the horizontal direction; the transform in the vertical direction can be performed as a single 4×N transform in the vertical direction. Similarly, when a 4×N prediction region contains two 2×N transform blocks, the transform operation of the two 2×N blocks in each direction (horizontal and vertical) can be conducted in parallel. Thus, there is no delay added in processing these smaller blocks than processing 4×4 regular-coded intra blocks.

TABLE 2-5
Entropy coding coefficient group size

| Block Size | Coefficient group Size |
|---|---|
| 1 × N, N ≥ 16 | 1 × 16 |
| N × 1, N ≥ 16 | 16 × 1 |
| 2 × N, N ≥ 8 | 2 × 8 |
| N × 2, N ≥ 8 | 8 × 2 |
| All other possible M × N cases | 4 × 4 |

For each sub-partition, reconstructed samples are obtained by adding the residual signal to the prediction signal. Here, a residual signal is generated by the processes such as entropy decoding, inverse quantization and inverse transform. Therefore, the reconstructed sample values of each sub-partition are available to generate the prediction of the next sub-partition, and each sub-partition is processed repeatedly. In addition, the first sub-partition to be processed is the one containing the top-left sample of the CU and then continuing downwards (horizontal split) or rightwards (vertical split). As a result, reference samples used to generate the sub-partitions prediction signals are only located at the left and above sides of the lines. All sub-partitions share the same intra mode. The followings are summary of interaction of ISP with other coding tools.
Multiple Reference Line (MRL): if a block has an MRL index other than 0, then the ISP coding mode will be inferred to be 0 and therefore ISP mode information will not be sent to the decoder.
Entropy coding coefficient group size: the sizes of the entropy coding subblocks have been modified so that they have 16 samples in all possible cases, as shown in Table 2-5. Note that the new sizes only affect blocks produced by ISP in which one of the dimensions is less than 4 samples. In all other cases coefficient groups keep the 4×4 dimensions.
CBF coding: it is assumed to have at least one of the sub-partitions has a non-zero CBF. Hence, if n is the number of sub-partitions and the first n−1 sub-partitions have produced a zero CBF, then the CBF of the n-th sub-partition is inferred to be 1.
Transform size restriction: all ISP transforms with a length larger than 16 points uses the DCT-II.
MTS flag: if a CU uses the ISP coding mode, the MTS CU flag will be set to 0 and it will not be sent to the decoder. Therefore, the encoder will not perform RD tests for the different available transforms for each resulting sub-partition. The transform choice for the ISP mode will instead be fixed and selected according the intra mode, the processing order and the block size utilized. Hence, no signalling is required. For example, let ty and ty be the horizontal and the vertical transforms selected respectively for the w×h sub-partition, where w is the width and h is the height. Then the transform is selected according to the following rules:
   If w=1 or h=1, then there is no horizontal or vertical transform respectively.
   If w≥4 and w≤16, t_{H}=DST-VII, otherwise, t_{H}=DCT-II
   If h≥4 and h≤16, t_{V}=DST-VII, otherwise, t_{V}=DCT-II

In ISP mode, all 67 intra prediction modes are allowed. PDPC is also applied if corresponding width and height is at least 4 samples long. In addition, the reference sample filtering process (reference smoothing) and the condition for intra interpolation filter selection doesn't exist anymore, and Cubic (DCT-IF) filter is always applied for fractional position interpolation in ISP mode.

2.15. Matrix weighted Intra Prediction (MIP)

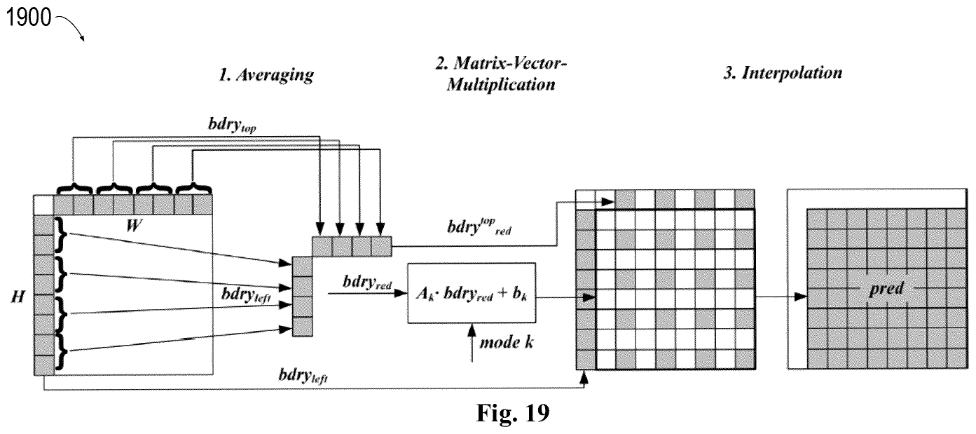

Matrix weighted intra prediction (MIP) method is a newly added intra prediction technique into VVC. For predicting the samples of a rectangular block of width W and height H, matrix weighted intra prediction (MIP) takes one line of H reconstructed neighbouring boundary samples left of the block and one line of W reconstructed neighbouring boundary samples above the block as input. If the reconstructed samples are unavailable, they are generated as it is done in the conventional intra prediction. The generation of the prediction signal is based on the following three steps, which are averaging, matrix vector multiplication and linear interpolation as shown in FIG. 19. FIG. 19 is a schematic diagram 1900 illustrating matrix weighted intra prediction process.

2.15.1. Averaging neighbouring samples

Among the boundary samples, four samples or eight samples are selected by averaging based on block size and shape. Specifically, the input boundaries bdry^{top} and bdry^{left} are reduced to smaller boundaries bdry_{red}^{top} and bdry_{red}^{left} by averaging neighbouring boundary samples according to predefined rule depends on block size. Then, the two reduced boundaries bdry_{red}^{top} and bdry_{red}^{left} are concatenated to a reduced boundary vector bdry_{red} which is thus of size four for blocks of shape 4×4 and of size eight for blocks of all other shapes. If mode refers to the MIP-mode, this concatenation is defined as follows:

$$\\ \begin{matrix}{bdry}_{red} = \{ \begin{matrix}[ {bdry}_{red}^{{}_{} top} , {bdry}_{red}^{{}_{} left} ] & for W = H = 4 and mode < 18 \\ [ {bdry}_{red}^{{}_{} left} , {bdry}_{red}^{{}_{} top} ] & for W = H = 4 and mode \geq 18 \\ [ {bdry}_{red}^{{}_{} top} , {bdry}_{red}^{{}_{} left} ] & for max ( W , H ) = 8 and mode < 10 \\ [ {bdry}_{red}^{{}_{} left} , {bdry}_{red}^{{}_{} top} ] & for max ( W , H ) = 8 and mode \geq 10 \\ [ {bdry}_{red}^{{}_{} top} , {bdry}_{red}^{{}_{} left} ] & for max ( W , H ) > 8 and mode < 6 \\ [ {bdry}_{red}^{{}_{} left} , {bdry}_{red}^{{}_{} top} ] & for max ( W , H ) > 8 and mode \geq 6\end{matrix} . & ( 2 ‐ 12 )\end{matrix}$$

### 2.15.2. Matrix Multiplication

A matrix vector multiplication, followed by addition of an offset, is carried out with the averaged samples as an input. The result is a reduced prediction signal on a subsampled set of samples in the original block. Out of the reduced input vector bdry_{red} a reduced prediction signal pred_{red}, which is a signal on the down-sampled block of width W_{red} and height H_{red} is generated. Here, W_{red} and H_{red} are defined as:

$$\\ \begin{matrix}{W}_{red} = \{ \begin{matrix}4 & for max ( W , H ) \leq 8 \\ min ( W , 8 ) & for max ( W , H ) > 8\end{matrix} & ( 2 ‐ 13 )\end{matrix}$$

$$\\ \begin{matrix}{H}_{red} = \{ \begin{matrix}4 & for max ( W , H ) \leq 8 \\ min ( H , 8 ) & for max ( W , H ) > 8\end{matrix} & ( 2 ‐ 14 )\end{matrix}$$

The reduced prediction signal pred_{red} is computed by calculating a matrix vector product and adding an offset:

pred_{red}=A·bdry_{red}+b. (2-15)

Here, A is a matrix that has W_{red}·H_{red} rows and 4 columns if W=H=4 and 8 columns in all other cases. b is a vector of size W_{red}·H_{red}. The matrix A and the offset vector b are taken from one of the sets S₀, S₁, S₂. One defines an index idx=idx(W, H) as follows:

$$\\ \begin{matrix}idx ( W , H ) = \{ \begin{matrix}0 & for W = H = 4 \\ 1 & for max ( W , H ) = 8 \\ 2 & for max ( W , H ) > 8\end{matrix} . & ( 2 ‐ 16 )\end{matrix}$$

Here, each coefficient of the matrix A is represented with 8 bit precision. The set S₀ consists of 16 matrices A₀ⁱ, i∈{0, . . . , 15} each of which has 16 rows and 4 columns and 16 offset vectors b₀ⁱ, i∈{0, . . . , 16} each of size 16. Matrices and offset vectors of that set are used for blocks of size 4×4. The set S₁ consists of 8 matrices A₁ⁱ, i∈{0, . . . , 7}, each of which has 16 rows and 8 columns and 8 offset vectors b₁ⁱ, i∈{0, . . . , 7} each of size 16. The set S₂ consists of 6 matrices A₂ⁱ, i∈{0, . . . , 5}, each of which has 64 rows and 8 columns and of 6 offset vectors b₂ⁱ, i∈{0, . . . , 5} of size 64.

### 2.15.3. Interpolation

The prediction signal at the remaining positions is generated from the prediction signal on the subsampled set by linear interpolation which is a single step linear interpolation in each direction. The interpolation is performed firstly in the horizontal direction and then in the vertical direction regardless of block shape or block size.

2.15.4. Signalling of MIP Mode and Harmonization with Other Coding Tools

For each Coding Unit (CU) in intra mode, a flag indicating whether an MIP mode is to be applied or not is sent. If an MIP mode is to be applied, MIP mode (predModeIntra) is signalled. For an MIP mode, a transposed flag (isTransposed), which determines whether the mode is transposed, and MIP mode Id (modeId), which determines which matrix is to be used for the given MIP mode is derived as follows

isTransposed=predModeIntra&1 modeld=predModeIntra>>1 (2-17)

MIP coding mode is harmonized with other coding tools by considering following aspects:
LFNST is enabled for MIP on large blocks. Here, the LFNST transforms of planar mode are used
The reference sample derivation for MIP is performed exactly as for the conventional intra prediction modes
For the up-sampling step used in the MIP-prediction, original reference samples are used instead of down-sampled ones
Clipping is performed before up-sampling and not after up-sampling
MIP is allowed up to 64×64 regardless of the maximum transform size

The number of MIP modes is 32 for sizeId=0, 16 for sizeId=1 and 12 for sizeId=2

### 2.16. Decoder-Side Intra Mode Derivation

In JEM-2.0 intra modes are extended to 67 from 35 modes in HEVC, and they are derived at encoder and explicitly signalled to decoder. A significant amount of overhead is spent on intra mode coding in JEM-2.0. For example, the intra mode signalling overhead may be up to 5˜10% of overall bitrate in all intra coding configuration. This contribution proposes the decoder-side intra mode derivation approach to reduce the intra mode coding overhead while keeping prediction accuracy.

To reduce the overhead of intra mode signalling, this contribution presents a decoder-side intra mode derivation (DIMD) approach. In the proposed approach, instead of signalling intra mode explicitly, the information is derived at both encoder and decoder from the neighbouring reconstructed samples of current block. The intra mode derived by DIMD is used in two ways:
1) For 2N×2N CUs, the DIMD mode is used as the intra mode for intra prediction when the corresponding CU-level DIMD flag is turned on;
2) For N×N CUs, the DIMD mode is used to replace one candidate of the existing MPM list to improve the efficiency of intra mode coding.

### 2.16.1. Templated Based Intra Mode Derivation

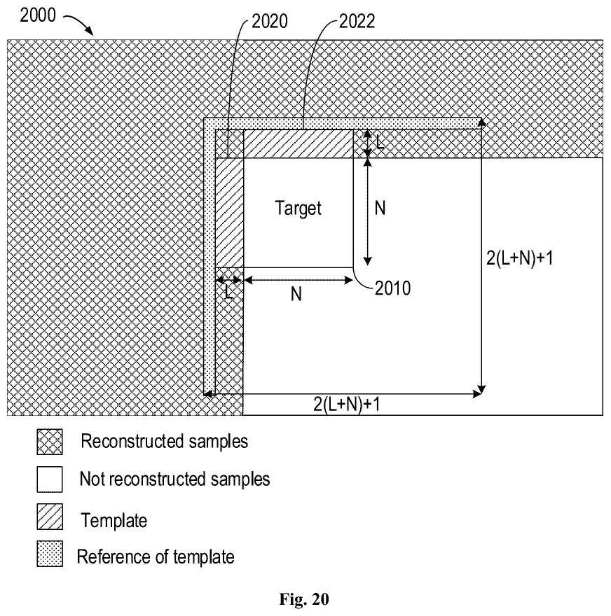

As illustrated in FIG. 20, the target denotes the current block (of block size N) for which intra prediction mode is to be estimated. The template (indicated by the patterned region in FIG. 20) specifies a set of already reconstructed samples, which are used to derive the intra mode. The template size is denoted as the number of samples within the template that extends to the above and the left of the target block, i.e., L. In the current implementation, a template size of 2 (i.e., L=2) is used for 4×4 and 8×8 blocks and a template size of 4 (i.e., L=4) is used for 16×16 and larger blocks. The reference of template (indicated by the dotted region in FIG. 20) refers to a set of neighbouring samples from above and left of the template, as defined by JEM-2.0. FIG. 20 is a schematic diagram 2000 illustrating target samples, template samples and the reference samples of template used in the DIMD. Unlike the template samples which are always from reconstructed region, the reference samples of template may not be reconstructed yet when encoding/decoding the target block. In this case, the existing reference samples substitution algorithm of JEM-2.0 is utilized to substitute the unavailable reference samples with the available reference samples.

For each intra prediction mode, the DIMD calculates the absolute difference (SAD) between the reconstructed template samples and its prediction samples obtained from the reference samples of the template. The intra prediction mode that yields the minimum SAD is selected as the final intra prediction mode of the target block.

### 2.16.2. DIMD for Intra 2N×2N CUs

For intra 2N×2N CUs, the DIMD is used as one additional intra mode, which is adaptively selected by comparing the DIMD intra mode with the optimal normal intra mode (i.e., being explicitly signalled). One flag is signalled for each intra 2N×2N CU to indicate the usage of the DIMD. If the flag is one, then the CU is predicted using the intra mode derived by DIMD; otherwise, the DIMD is not applied and the CU is predicted using the intra mode explicitly signalled in the bit-stream. When the DIMD is enabled, chroma components always reuse the same intra mode as that derived for luma component, i.e., DM mode.

Additionally, for each DIMD-coded CU, the blocks in the CU can adaptively select to derive their intra modes at either PU-level or TU-level. Specifically, when the DIMD flag is one, another CU-level DIMD control flag is signalled to indicate the level at which the DIMD is performed. If this flag is zero, it means that the DIMD is performed at the PU level and all the TUs in the PU use the same derived intra mode for their intra prediction; otherwise (i.e., the DIMD control flag is one), it means that the DIMD is performed at the TU level and each TU in the PU derives its own intra mode.

Further, when the DIMD is enabled, the number of angular directions increases to 129, and the DC and planar modes still remain the same. To accommodate the increased granularity of angular intra modes, the precision of intra interpolation filtering for DIMD-coded CUs increases from 1/32-pel to 1/64-pel. Additionally, in order to use the derived intra mode of a DIMD coded CU as MPM candidate for neighbouring intra blocks, those 129 directions of the DIMD-coded CUs are converted to “normal” intra modes (i.e., 65 angular intra directions) before they are used as MPM.

### 2.16.3. DIMD for Intra N×N CUs

In the proposed method, intra modes of intra N×N CUs are always signalled. However, to improve the efficiency of intra mode coding, the intra modes derived from DIMD are used as MPM candidates for predicting the intra modes of four PUs in the CU. In order to not increase the overhead of MPM index signalling, the DIMD candidate is always placed at the first place in the MPM list and the last existing MPM candidate is removed. Also, pruning operation is performed such that the DIMD candidate will not be added to the MPM list if it is redundant.

### 2.16.4. Intra Mode Search Algorithm of DIMD

In order to reduce encoding/decoding complexity, one straightforward fast intra mode search algorithm is used for DIMD. Firstly, one initial estimation process is performed to provide a good starting point for intra mode search. Specifically, an initial candidate list is created by selecting N fixed modes from the allowed intra modes. Then, the SAD is calculated for all the candidate intra modes and the one that minimizes the SAD is selected as the starting intra mode. To achieve a good complexity/performance trade-off, the initial candidate list consists of 11 intra modes, including DC, planar and every 4-th mode of the 33 angular intra directions as defined in HEVC, i.e., intra modes 0, 1, 2, 6, 10 . . . 30, 34.

If the starting intra mode is either DC or planar, it is used as the DIMD mode. Otherwise, based on the starting intra mode, one refinement process is then applied where the optimal intra mode is identified through one iterative search. It works by comparing at each iteration the SAD values for three intra modes separated by a given search interval and maintain the intra mode that minimize the SAD. The search interval is then reduced to half, and the selected intra mode from the last iteration will serve as the center intra mode for the current iteration. For the current DIMD implementation with 129 angular intra directions, up to 4 iterations are used in the refinement process to find the optimal DIMD intra mode.

### 2.17. Decoder-Side Intra Mode Derivation by Calculating the Gradients of Neighbouring Samples

Three angular modes are selected from a Histogram of Gradient (HoG) computed from the neighboring pixels of current block. Once the three modes are selected, their predictors are computed normally and then their weighted average is used as the final predictor of the block. To determine the weights, corresponding amplitudes in the HoG are used for each of the three modes. The DIMD mode is used as an alternative prediction mode and is always checked in the FullRD mode.

Current version of DIMD has modified some aspects in the signaling, HoG computation and the prediction fusion. The purpose of this modification is to improve the coding performance as well as addressing the complexity concerns raised during the last meeting (i.e., throughput of 4×4 blocks). The following sections describe the modifications for each aspect.

### 2.17.1. Signalling

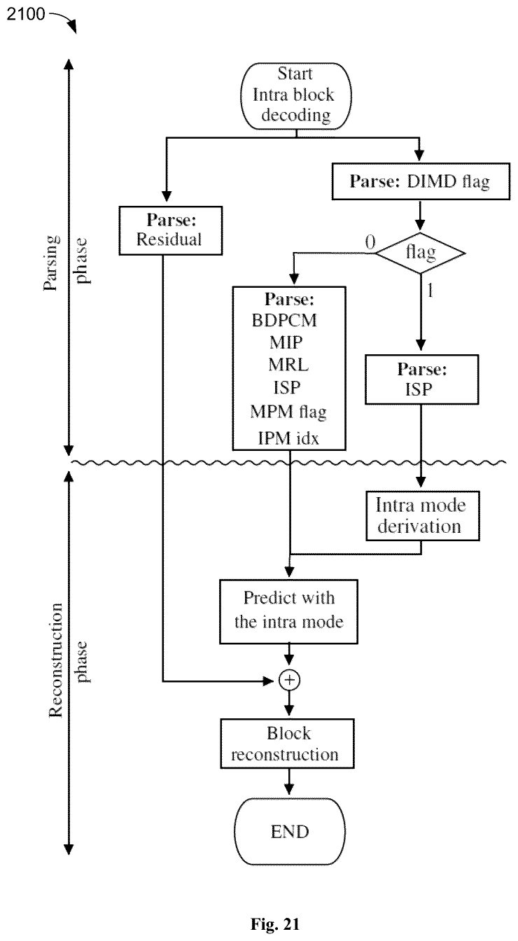

FIG. 21 shows the order of parsing flags/indices in VTM5, integrated with the proposed DIMD. As can be seen, the DIMD flag of the block is parsed first using a single CABAC context, which is initialized to the default value of 154.
If flag==0, then the parsing continues normally.
Else (if flag==1), only the ISP index is parsed and the following flags/indices are inferred to be zero: BDPCM flag, MIP flag, MRL index. In this case, the entire IPM parsing is also skipped.
During the parsing phase, when a regular non-DIMD block inquires the IPM of its DIMD neighbor, the mode PLANAR_IDX is used as the virtual IPM of the DIMD block.

### 2.17.2. Texture Analysis

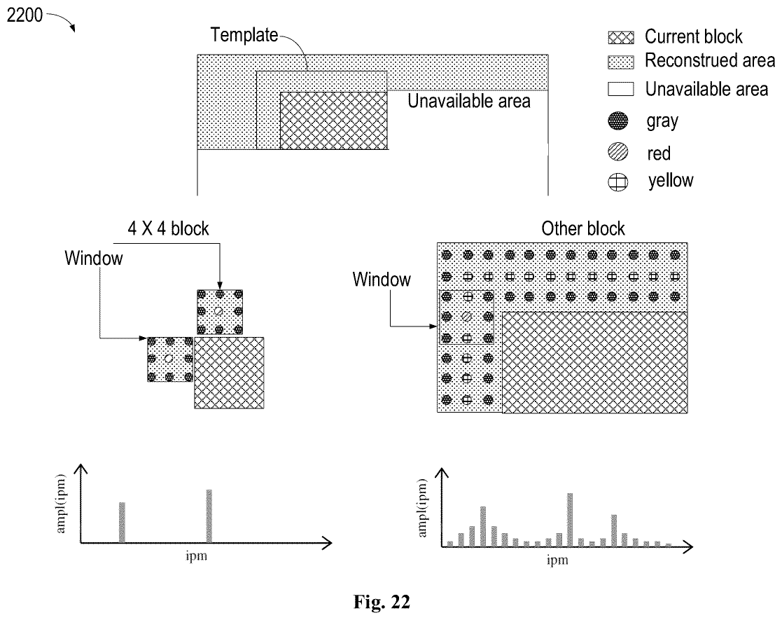

The texture analysis of DIMD includes a Histogram of Gradient (HoG) computation (FIG. 22). The HoG computation is carried out by applying horizontal and vertical Sobel filters on pixels in a template of width 3 around the block. Except, if above template pixels fall into a different CTU, then they will not be used in the texture analysis.

Once computed, the IPMs corresponding to two tallest histogram bars are selected for the block.

In previous versions, all pixels in the middle line of the template were involved in the HoG computation. However, the current version improves the throughput of this process by applying the Sobel filter more sparsely on 4×4 blocks. To this aim, only one pixel from left and one pixel from above are used. This is shown in FIG. 22. FIG. 22 is a schematic diagram 2200 illustrating HoG computation from a template of width 3 pixels.

In addition to reduction in the number of operations for gradient computation, this property also simplifies the selection of best 2 modes from the HoG, as the resulting HoG cannot have more than two non-zero amplitudes.

### 2.17.3. Prediction Fusion

The conventional method also uses a fusion of three predictors for each block. However, the choice of prediction modes is different and makes use of the conventional combined hypothesis intra-prediction method, where the Planar mode is considered to be used in combination with other modes when computing an intra-predicted candidate. In the current version, the two IPMs corresponding to two tallest HoG bars are combined with the Planar mode.

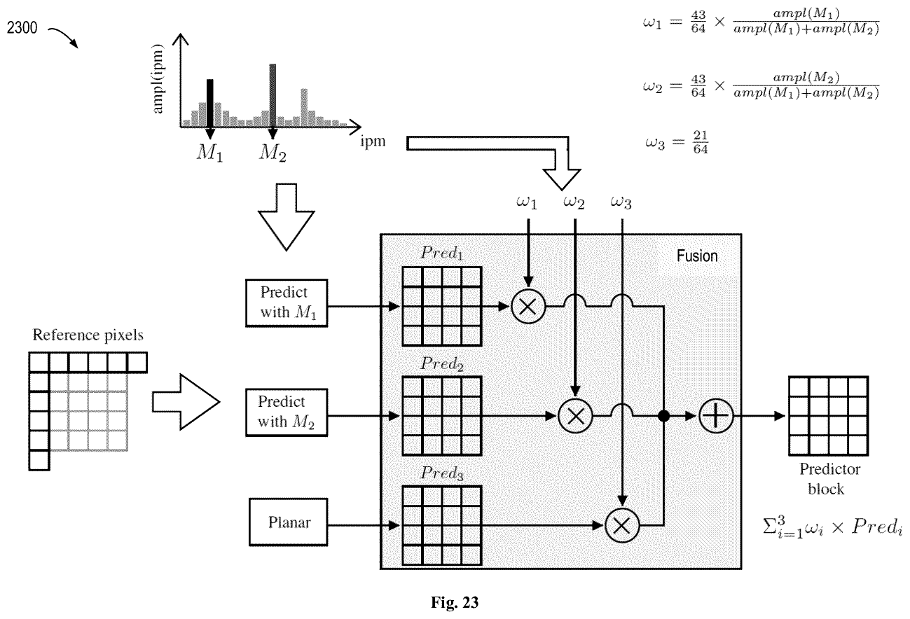

The prediction fusion is applied as a weighted average of the above three predictors. To this aim, the weight of planar is fixed to 21/64 (˜⅓). The remaining weight of 43/64 (˜⅔) is then shared between the two HoG IPMs, proportionally to the amplitude of their HoG bars. FIG. 23 visualises this process. FIG. 23 is a schematic diagram 2300 illustrating prediction fusion by weighted averaging of two HoG modes and planar

### 2.18. Template-Based Intra Mode Derivation (TIMD)

This contribution proposes a template-based intra mode derivation (TIMD) method using MPMs, in which a TIMD mode is derived from MPMs using the neighbouring template. The TIMD mode is used as an additional intra prediction method for a CU.

### 2.18.1. TIMD Mode Derivation

For each intra prediction mode in MPMs, The SATD between the prediction and reconstruction samples of the template is calculated. The intra prediction mode with the minimum SATD is selected as the TIMD mode and used for intra prediction of current CU. Position dependent intra prediction combination (PDPC) is included in the derivation of the TIMD mode.

### 2.18.2. TIMD Signalling

A flag is signalled in sequence parameter set (SPS) to enable/disable the proposed method. When the flag is true, a CU level flag is signalled to indicate whether the proposed TIMD method is used. The TIMD flag is signalled right after the MIP flag. If the TIMD flag is equal to true, the remaining syntax elements related to luma intra prediction mode, including MRL, ISP, and normal parsing stage for luma intra prediction modes, are all skipped.

2.18.3. Interaction with New Coding Tools

A DIMD method with prediction fusion using Planar was integrated in EE2. When EE2 DIMD flag is equal to true, the proposed TIMD flag is not signalled and set equal to false.

Similar to PDPC, Gradient PDPC is also included in the derivation of the TIMD mode.

When secondary MPM is enabled, both the primary MPMs and the secondary MPMs are used to derive the TIMD mode.

6-tap interpolation filter is not used in the derivation of the TIMD mode.

### 2.18.4. Modification of MPM List Construction in the Derivation of TIMD Mode

During the construction of MPM list, intra prediction mode of a neighbouring block is derived as Planar when it is inter-coded. To improve the accuracy of MPM list, when a neighbouring block is inter-coded, a propagated intra prediction mode is derived using the motion vector and reference picture and used in the construction of MPM list. This modification is only applied to the derivation of the TIMD mode.

2.18.5. TIMD with Fusion

Instead of selecting the only one mode with the smallest SATD cost, this contribution proposes to choose the first two modes with the smallest SATD costs for the intra modes derived using TIMD method and then fuse them with the weights, and such weighted intra prediction is used to code the current CU.

The costs of the two selected modes are compared with a threshold, in the test the cost factor of 2 is applied as follows:

costMode2<2×costMode1.

If this condition is true, the fusion is applied, otherwise the only model is used.

Weights of the modes are computed from their SATD costs as follows:

weight1=costMode2/(costMode1+costMode2)

weight2=1−weight1

### 3. PROBLEMS

There are 3 modes (i.e., LM, LM_T, and LM_L) in current design of cross component linear model (CCLM), and 3 modes (i.e., MMLM, MMLM_T, and MMLM_L) in current design of multi-model linear model (MMLM), the indication of using which mode for a block is signalled in the bitstream. However, the signalling of the indication may limit the compression efficiency.

### 4. EMBODIMENTS

The detailed embodiments below should be considered as examples to explain general concepts. These embodiments should not be interpreted in a narrow way. Furthermore, these embodiments can be combined in any manner.

A cross component intra prediction (CCIP) method may refer to a coding method that uses samples in the 1^{st} component to derive the predicted/reconstructed samples of the 2^{nd} component (e.g., using a linear model). The 1^{st} component may refer to luma component and the 2^{nd} component may refer to chroma components. For example, CCIP may refer to CCLM or MMLM. The neighbouring samples of the 2^{nd} component and the corresponding neighbouring samples of the 1^{st} component are used to derive the parameters of the model (e.g., linear model) of CCIP. The predicted samples of current block (P) with the 2^{nd} component (e.g., Cb or Cr) may be derived using the derived parameters (S) and the corresponding samples of current block (R) from the 1^{st} component which may be down-sampled and or not, such as P=f(R, S). When the linear model is used in CCIP, one example of the derivation of the predicted samples of current block may be P=αR+β.

Similar to CCLM and MMLM, CCIP may have 3 modes namely, CCIP mode, CCIP_T mode, and CCIP_L mode. CCIP mode may use the above and left samples to derive parameters of the model, and CCIP_T mode may use the above samples to derive parameters of the model, and CCIP_L mode may use and left samples to derive parameters of the model.

In this disclosure, the “reference/training samples” may refer to samples used to derive the parameters (e.g., α and β) of the model (e.g., linear model) in CCIP. The “reference/training samples” may consist of samples from component A (e.g., Cb or Cr) which is same as the component of current block, and the corresponding samples from component B (e.g., Y) which may be down-sampled (e.g., in YUV420 colour format) or not. An example of reference/training samples is shown in FIG. 9.

The “reference/training samples” of a region (e.g., a block or a template) may refer to those reference samples used to derive the parameters of the CCIP mode which is used to further derive the predicted samples of the region (e.g., a block or template).

In the disclosure, a neighbouring (adjacent or non-adjacent) sample is “unavailable” if it is located in a different video processing unit (e.g., out of the current picture, or current sub-picture, or current tile, or current slice, or current brick, or current CTU, or current processing unit, or any other current video unit) or has not been reconstructed.

The term ‘block’ may represent a coding block (CB), or a coding unit (CU), or a prediction block (PB), or a prediction unit (PU), or a transform block (TB), or a transform unit (TU), or a coding tree block (CTB), or a coding tree unit (CTU), or a rectangular region of samples/pixels.

### Mode Derivation for CCIP at Decoder

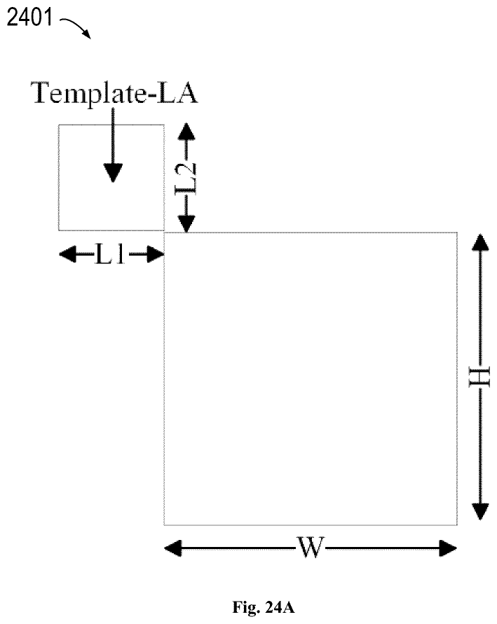

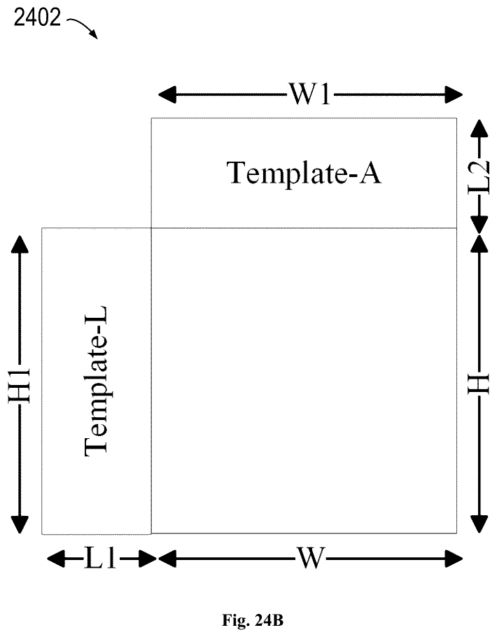

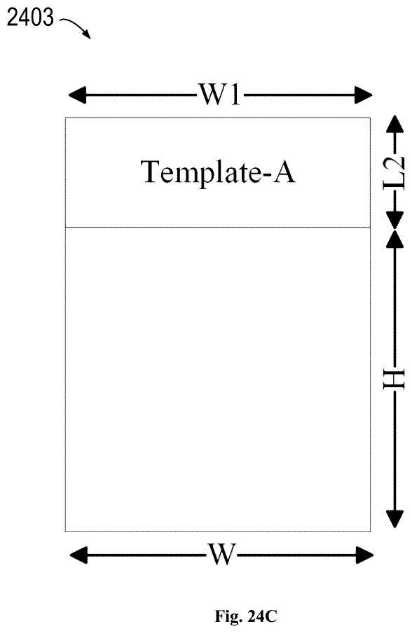

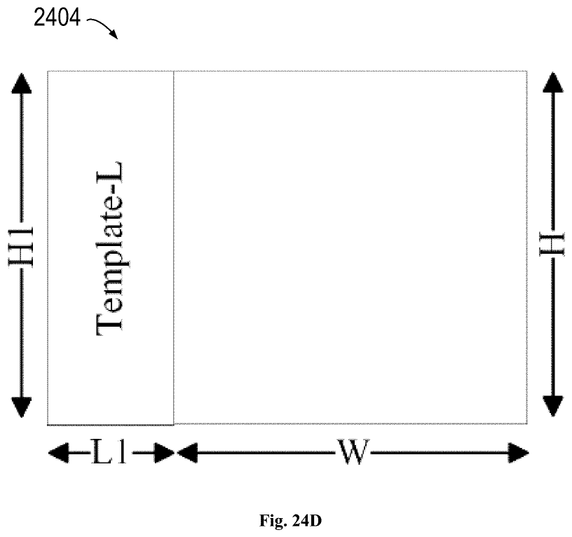

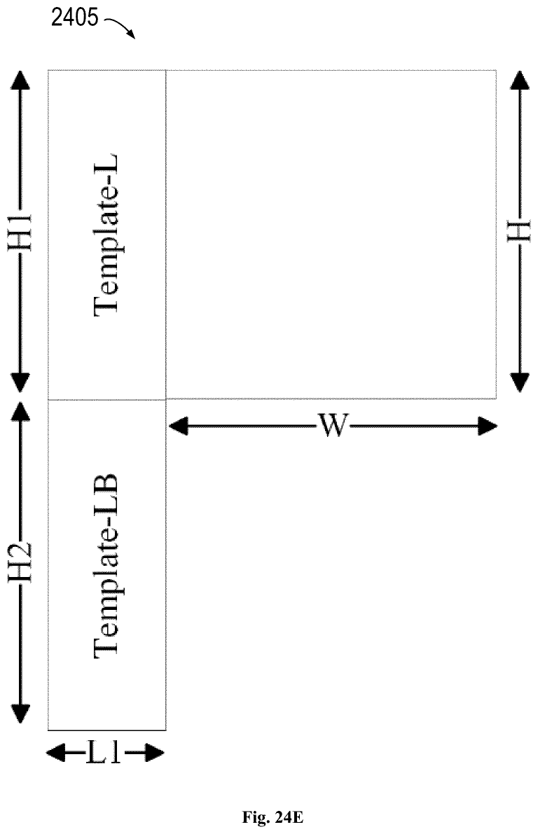

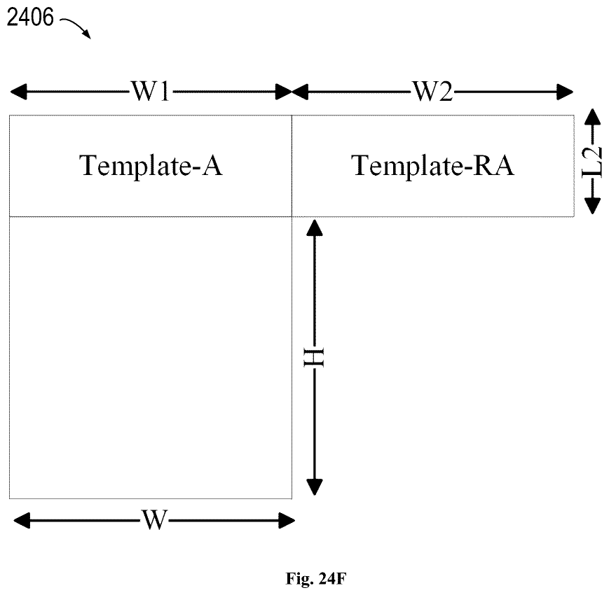

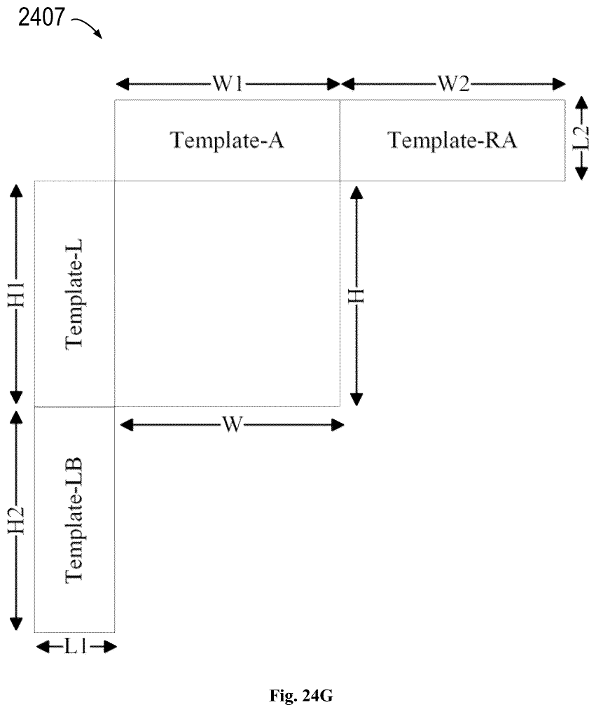

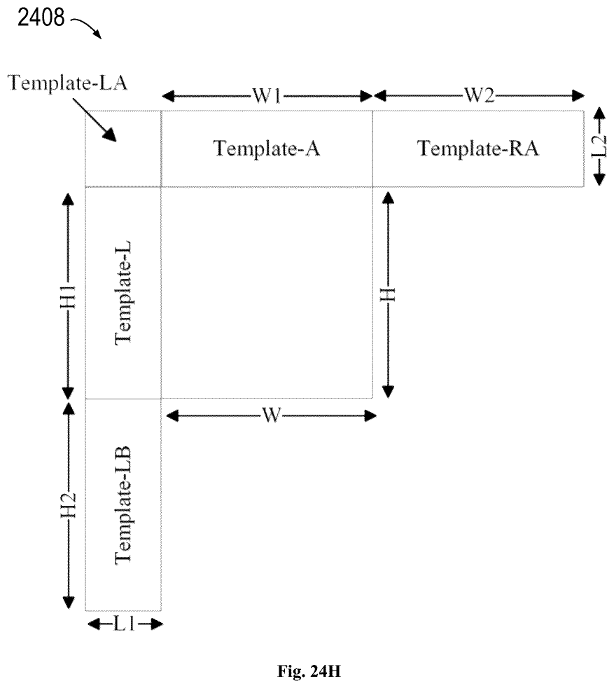

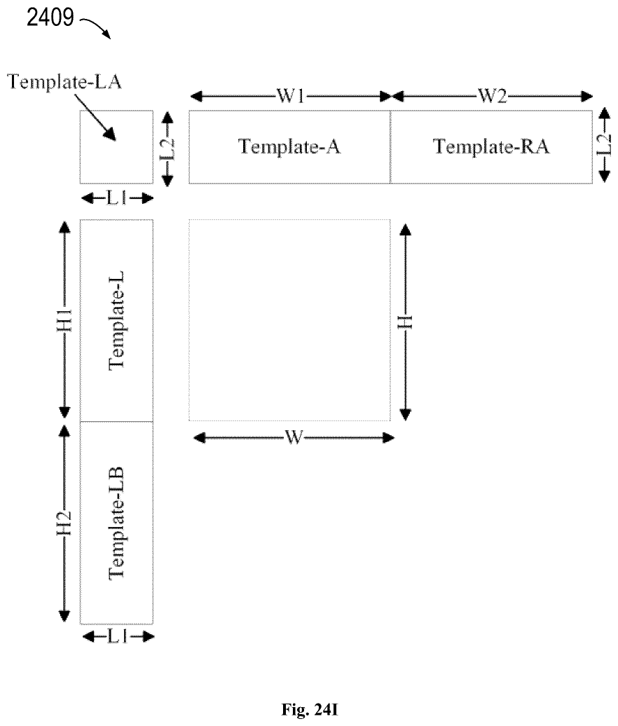

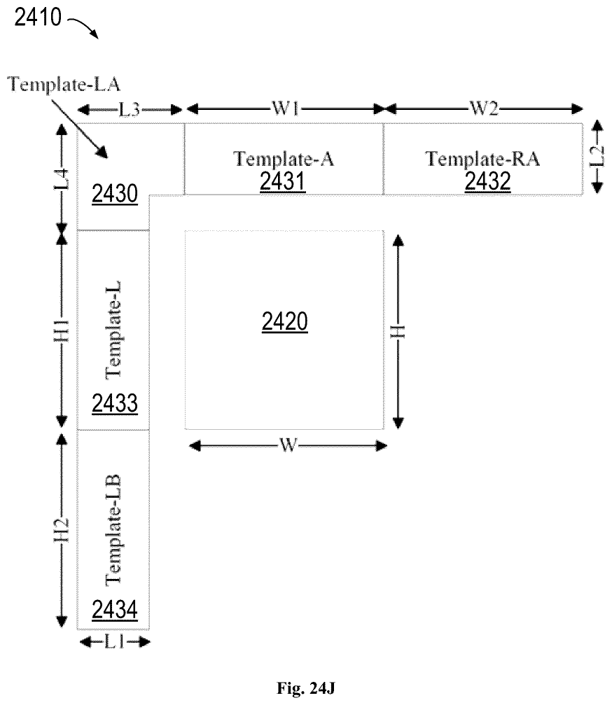

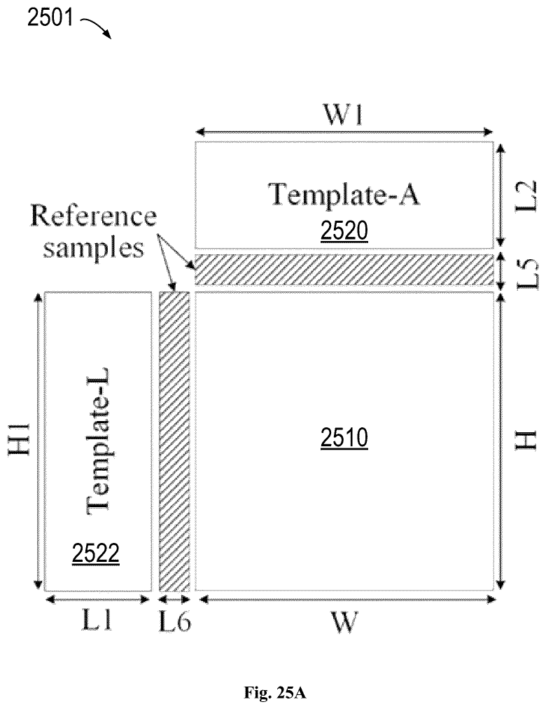

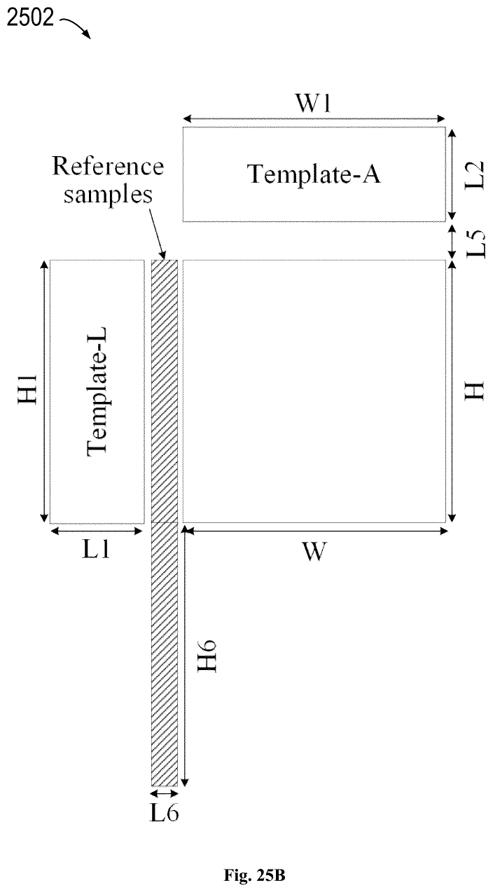

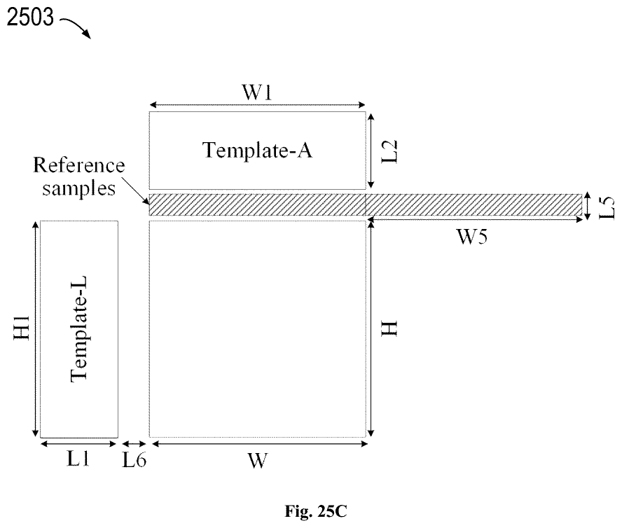

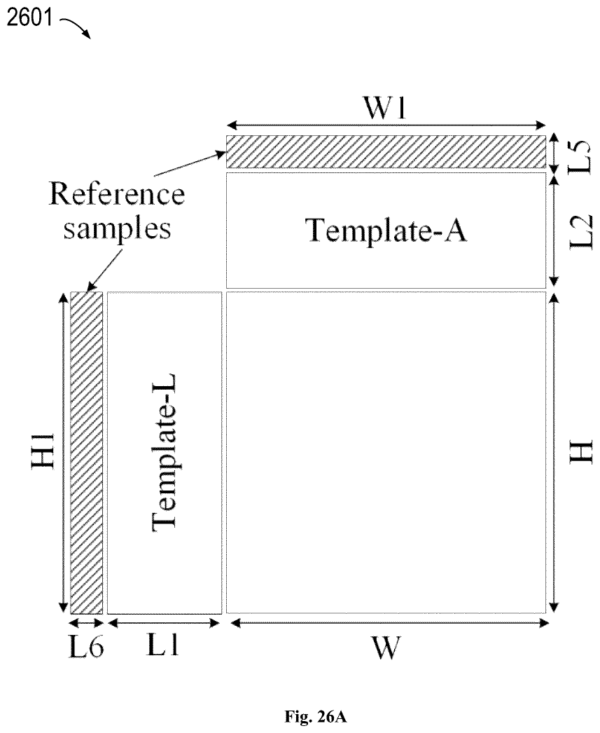

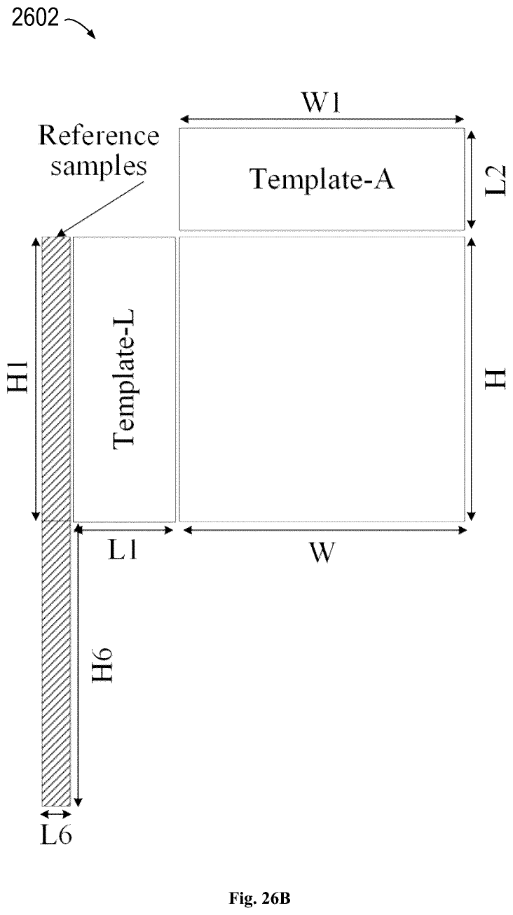

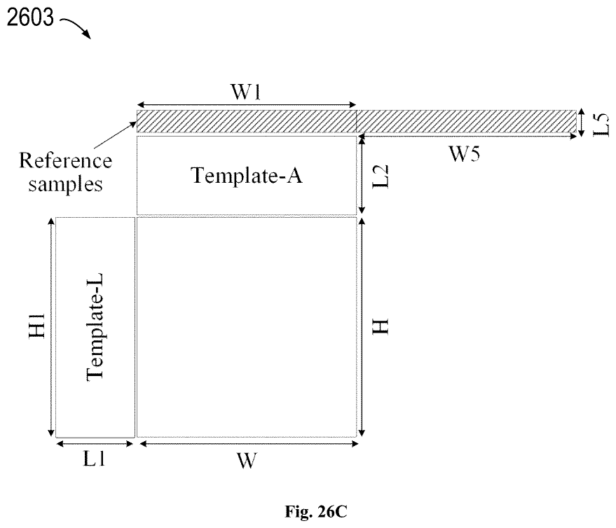

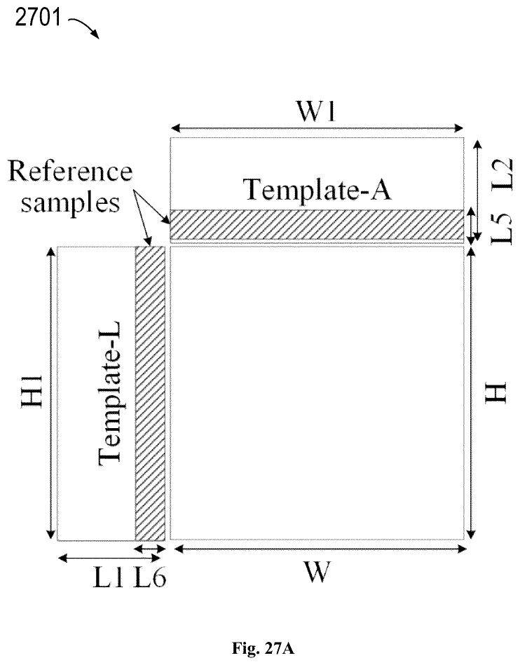

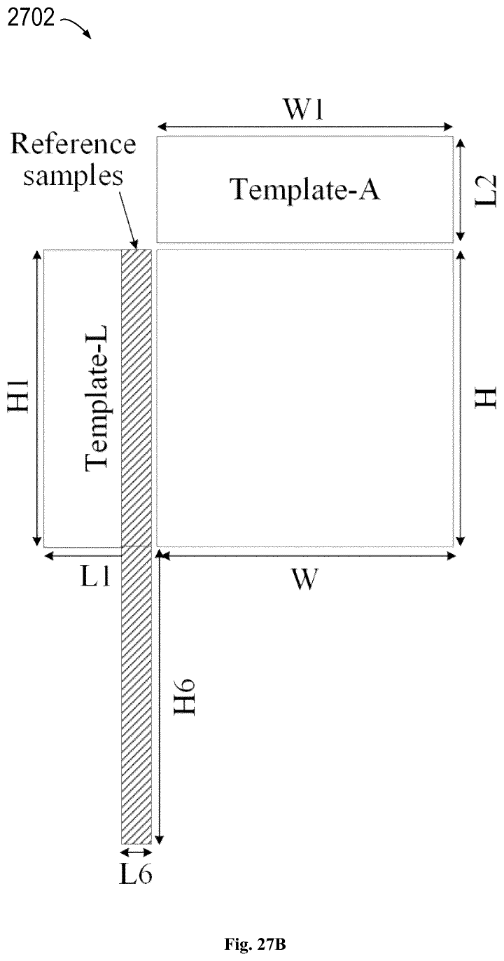

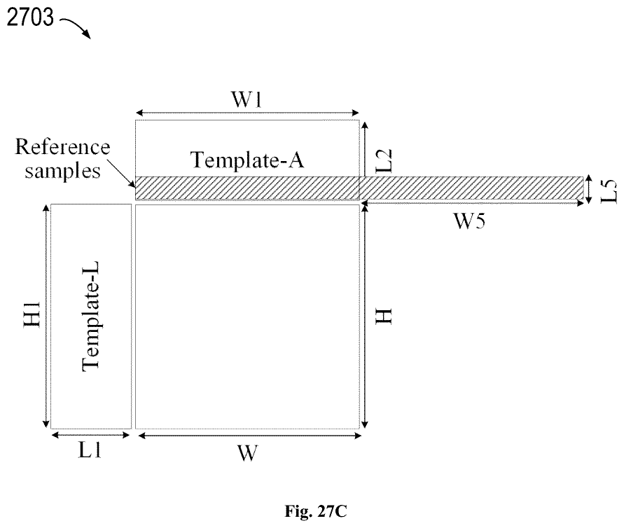

1. Instead of signalling a CCIP mode for a current block, it is proposed to derive the CCIP mode at decoder using the reconstructed/prediction samples of neighbouring blocks or samples in a same and/or different colour component or residual information, wherein the coded mode of current block is denoted as DCCIP_MODE.
a. In one example, a template may be utilized to derive the CCIP mode at the decoder side wherein the template consists of neighbouring reconstructed samples from same and/or different colour component.
   i. Alternatively, furthermore, a CCIP mode candidate list may be constructed and the CCIP mode is derived from the CCIP mode candidate list.
      1) In one example, the CCIP mod candidate list may consist of one or more CCIP modes, such as LM, and/or LM_T, and/or LM_L, and/or MMLM, and/or MMLM_T, and/or MMLM_L.
   ii. Alternatively, furthermore, a set of parameters of a CCIP mode may be derived using the reference/training samples of the template, and the predicted samples of the template may be derived using the derived parameters and the corresponding samples of the template from the different colour component.
   iii. Alternatively, furthermore, partial or all CCIP modes in the CCIP mode candidate list may be used to derive the predicted samples of the template, a cost is calculated using the predicted samples and the reconstructed samples of the template for a CCIP mode, and the CCIP mode with the minimum cost is selected as the derived CCIP mode.
b. In one example, CCIP may be interpreted as CCLM and/or MMLM.
   i. In one example, CCIP modes may refer to LM, and/or LM_T, and/or LM_L.
   ii. In one example, CCIP modes may refer to MMLM, and/or MMLM_T, and/or MMLM_L.
   iii. In one example, CCIP modes may refer to both CCLM modes and MMLM modes.
   iv. In one example, whether to use CCLM or MMLM, and/or which mode of CCLM or MMLM is used may be determined at decoder side.
c. In one example, the derived CCIP mode may be a CCIP mode that can be signalled explicitly.
   i. Alternatively, the derived CCIP mode may be a CCIP mode that cannot be signalled explicitly.
      1) For example, MMLM with more than two categories may be derived implicitly but it may not be signalled explicitly.
      2) In another example, a CCIP method (such as CCLM or MMLM) may be derived implicitly, with different training sample set or different parameter derivation methods, from the corresponding CCIP method signalled.
d. In one example, the template used to derive the CCIP mode may consist of the adjacent and/or non-adjacent neighbouring reconstructed samples.
   i. In one example, as shown in FIGS. 24A-24J, “Template-LA” consists of the neighbouring left-above reconstructed samples, and “Template-L” consists of the neighbouring left reconstructed samples, and “Template-A” consists of the neighbouring above reconstructed samples, and “Template-LB” consists of the neighbouring left-below reconstructed samples, and “Template-RA” consists of the neighbouring right-above reconstructed samples. FIGS. 24A-24J are schematic diagrams illustrating templates used in the derivation of IPM for chroma.
   ii. In one example, the template may consist of the (adjacent and/or non-adjacent) neighbouring left, and/or above, and/or left-above, and/or left-below, and/or right-above reconstructed samples.
      1) In one example, the template may only consist of neighbouring left-above reconstructed samples, or left reconstructed samples, or above reconstructed samples, or left-below reconstructed samples, or right-above reconstructed samples. Such as, one of “Template-LA” (e.g., FIG. 24A), “Template-L” (e.g., FIG. 24D), “Template-A” (e.g., FIG. 24C), “Template-LB”, and “Template-RA”.
      2) In one example, the template may consist of the combined neighbouring reconstructed samples from left-above, and/or left, and/or above, and/or left-below, and/or right-above reconstructed samples.
         a) In one example, the template may consist of “Template-L” and “Template-A”, such as example shown in FIG. 24B.
         b) In one example, the template may consist of “Template-L” and “Template-LB”, such as an example shown in FIG. 24E.
         c) In one example, the template may consist of “Template-A” and “Template-RA”, such as an example shown in FIG. 24F.
         d) In one example, the template may consist of “Template-A”, “Template-L”, “Template-LB”, and “Template-RA”, such as an example shown in FIG. 24G.
         e) In one example, the template may consist of “Template-LA”, “Template-A”, “Template-L”, “Template-LB”, and “Template-RA”, such as an example shown in FIG. 24H.
         i. In one example, the template may be non-adjacent, such as an example shown in FIG. 241 and FIG. 24J.
   iii. In one example, the template shape/size/dimensions may be pre-defined, or signalled in the bitstream, or dependent on coding information (e.g., dimensions of current block). As shown in FIGS. 24A-24J, denote the width and height of “Template-A” as W1 and L2, denote the width and height of “Template-RA” as W2 and L2, denote the width and height of “Template-L” as L1 and H1, denote the width and height of “Template-LB” as L1 and H2, denote the width and height of “Template-LA” as L3 and L4.
      1) In one example, W1 may be dependent on W, such as W1=W.
      2) In one example, L2 may be dependent on W and/or H, such as L2=s1×H wherein s1 may be ½ or ¼ or ⅛ or 1/16.
      3) In one example, L1 may be dependent on H and/or W, such as L1=s2×W wherein s2 may be ½ or ¼ or ⅛ or 1/16.
      4) In above examples, s1 and s2 may be dependent on W and/or H, or signalled in the bitstream, or pre-defined.
      5) In one example, W2 and H2 may be dependent on W and/or H, such as W2=W and H2=H, or W2=H and H2=W.
      6) In one example, L3 and L4 may be dependent on L1 and/or L2, such as L3=L1 and L4=L2.
      7) In one example, the template size and/or template dimensions may be dependent on whether partial or all samples in the template are available.
e. In one example, during the derivation of the CCIP mode with the template, the reference/training samples (e.g., reference samples in FIGS. 25A-25C) consisting of neighbouring samples of 1^{st} component (e.g., Cb and/or Cr) and the corresponding samples of 2^{nd} component (e.g., Y) used to derive the parameters of the model of the CCIP mode for the template may be same as those reference/training samples used to derive the parameters of the model of the CCIP mode for the derivation of the predicted samples of current block. FIGS. 25A-25C are schematic diagrams illustrating reference samples of the template.
   i. In one example, how to derive the reference/training samples of the template may be same as the method to derive the reference/training samples of current block.
   ii. In one example, the neighbouring adjacent above and left reconstructed samples may be used as the reference/training samples of the template, such as an example shown in FIG. 25A.
      1) In one example, the reference/training samples of the template may be used to derive the parameters of CCIP mode.
   iii. In one example, the neighbouring adjacent left and left-below reconstructed samples may be used as the reference/training samples of the template a, such as an example shown in FIG. 25B.
      1) In one example, the reference/training samples of the template may be used to derive the parameters of CCIP_L mode.
   iv. In one example, the neighbouring adjacent above and right-above reconstructed samples may be used as the reference/training samples of the template, such as shown am example in FIG. 25C.
      1) In one example, the reference/training samples of the template may be used to derive the parameters of CCIP_A mode.
   v. In above examples, the shape/size and/or number of the reference/training samples of the template may be same as those of the reference/training samples for current block.
      1) In one example, one row or one column of reference/training samples may be used, such as L5=L6=1.
      2) In one example, different sets of reference/training samples are used for different CCIP modes.
         a) In one example, W+H reference/training samples are used for CCIP mode.
         b) In one example, W+W5 reference/training samples are used for CCIP_A mode.
         c) In one example, H+H6 reference/training samples are used for CCIP_L mode.
      3) In one example, the width of right-above reference/training samples may be dependent on the width of current block, and/or the height of current block, and/or the number of available right-above reference samples (denoted by numTopRight).
         a) In one example, W5=Min(H, numTopRight), or W5=Min(W, numTopRight), or W5=numTopRight, or W5=W, or W5=H.
      4) In one example, the height of left-below reference/training samples may be dependent on the width of current block, and/or the height of current block, and/or the number of available left-below reference samples (denoted by numLeftBelow).
         a) In one example, H6=Min (W, numLeftBelow), or H6=Min (H, numLeftBelow), or H6=numLeftBelow, or H6=H, or H6=W.
f. In one example, during the derivation of the CCIP mode with the template, the reference/training samples (e.g., reference samples in FIGS. 25A-25C) consisting of neighbouring samples of 1^{st} component (e.g., Cb and/or Cr) and the corresponding samples of 2^{nd} component (e.g., Y) used to derive the parameters of the model of the CCIP mode for the template may be different from those reference/training samples used to derive the parameters of the model of the CCIP mode for the derivation of the predicted samples of current block.
   i. In one example, more than one row and/or column of reference/training samples may be used, such as L5=2 and L6=2.
   ii. In one example, the reconstructed samples located left and/or above of the template may be used as the reference/training samples, such as an example shown in FIGS. 26A-26C. FIGS. 26A-26C are schematic diagrams illustrating reference samples of the template located at left and above of the template.
   iii. In one example, partial or all of the reference/training samples may be inside the template, such as an example shown in FIGS. 27A-27C. FIGS. 27A-27C are schematic diagrams illustrating partial or all of the reference samples of the template inside the template.
g. In one example, how to derive the parameters of the model of the CCIP mode for the template may be same as or different from the derivation of the parameters of the model of the CCIP mode for current block.
   i. In one example, when the linear model is used in CCIP for current block, the Min-Max method may be used to derive parameters of the model of CCIP mode for the template.
   ii. In one example, when the linear model is used in CCIP for the block, the Least-Mean-Square (LMS) method may be used to derive parameters of the model of CCIP mode for the template.
   iii. In one example, how to derive the parameters (e.g., Min-Max or LMS) of the model of the CCIP mode may be signalled in the bitstream, or pre-defined, dependent on coding information.
h. In one example, the sum of the absolute transformed difference (SATD) between the predicted samples and the reconstructed samples of the template may be calculated and used to derive the cost. (e.g., SATD may be used as the cost).
   i. Alternatively, the sum of the squared errors (SSE), or the sum of the absolute difference (SAD), or the mean removal sum of the absolute difference (MRSAD), or a subjective quality metric (e.g., the structural similarity index measure (SSIM)) may be calculated and used to derive the cost. (e.g., SSE or SAD or MRSAD or SSIM may be used as the cost).
   ii. Alternatively, the cost may be calculated in a form of D+lambda×R, wherein D is a metric of distortion such as SAD, SATD, SSE et. al, R represents the number of bits under consideration and lambda is a pre-defined factor or derived on-the-fly.
   iii. In one example, partial samples or all samples of the template may be used to calculate the cost.
   iv. In one example, both of the two chroma components (e.g., Cb and Cr in YCbCr colour format, or B and R in RGB colour format) may be used to calculate the cost. Denote the cost of the first chroma component as C1, and the cost of the second chroma component as C2, and the total cost as C.
      a) In one example, C=C1+C2.
      b) In one example, C=w1×C1+w2×C2, wherein w1 and w2 are weighted factors.
         i. In one example, w1=1−w2.
      c) In one example, C=(w1×C1+w2×C2+offset)>>shift, wherein w1, w2, offset, and shift are integers.
      d) In above examples, w1, w2, offset, and shift may be signalled in the bitstream, or pre-defined, or derived on-the-fly, or dependent on coding information.

2. In one example, the CCIP mode may be derived using above methods for each chroma component individually.
a. In one example, the derivation of the CCIP mode may be different for different chroma components.
b. Alternatively, the derivation of the CCIP mode for different chroma components may be the same.
c. In one example, the derived CCIP mode for the chroma components may be different.
d. Alternatively, the derived CCIP mode for the chroma components may be the same.

3. In one example, the derived CCIP mode may be used to derive the predicted/reconstructed samples of at least one colour components.
a. In one example, the derived CCIP mode may be used to derive the predicted/reconstructed samples of Cb and/or Cr components.
b. In one example, the derived CCIP mode may be used to derive the predicted/reconstructed samples of the 1^{st} component and the predicted/reconstructed samples of the 2^{nd} component may be derived using one or more signalled/pre-defined CCIP modes or traditional intra prediction modes.

4. In above examples, more than one CCIP mode may be derived and use which CCIP mode in the intra prediction for current block may be signalled in the bitstream, and/or determined on-the-fly, and/or dependent on coding information.

5. In one example, fusion of the predicted signals generated by more than one mode may be used as the final prediction of current block.
a. In one example, the modes used in fusion may consist of one or more derived CCIP modes, and/or one or more pre-defined or signalled CCIP modes, and/or one or more traditional intra prediction modes.
   i. In one example, the pre-defined or signalled CCIP modes may be cross-component prediction mode such as LM, and/or LM_T, and/or LM_L, and/or MMLM, and/or MMLM_T, and/or MMLM_L.
   ii. In one example, the pre-defined or signalled traditional intra prediction modes may be Planar, and/or DC, and/or horizontal mode, and/or vertical mode, and/or diagonal mode, and/or vertical diagonal mode.
b. In one example, different fusion methods may be applied, in which different fusion methods may refer to use different modes (e.g., CCIP modes and/or traditional intra prediction modes) and/or different weighted factors in the fusion.
   i. In one example, the weighted factors may be dependent on the costs of the CCIP modes during the derivation of the CCIP modes.
c. In above examples, whether to and/or how to fuse the predicted signals, and/or the number of the modes used in fusion, and/or the indication of the fusion method may be signalled in the bitstream, and/or determined on-the-fly, and/or dependent on coding information.
   i. In one example, whether to and/or how to apply the fusion method may be dependent on the costs of the derived CCIP modes.
   ii. In one example, denote the cost of the best derived CCIP as Cost1, and the cost the second best derived CCIP as Cost2, when Cost2 is less than T×Cost1, the fusion method may be applied, wherein T is a cost factor.

### Indication of Mode Derivation for CCIP (DCCIP_MODE)

6. Indication of the DCCIP_MODE mode may be derived on-the-fly.
a. In one example, if the current block is not coded with the linear model mode (e.g., including CCLM, MMLM), the DCCIP_MODE mode may be inferred to be used.
b. In one example, if the current block is not coded with the traditional intra prediction modes (e.g., chroma DM mode, or Planar/DC/horizontal mode/vertical mode), the DCCIP_MODE mode may be inferred to be used.

7. Indication of the mode derivation for DCCIP_MODE may be conditionally signalled wherein the condition may include:
a. whether CCIP is allowed
b. block dimensions and/or block size
c. block depth
d. slice/picture type and/or partition tree type (single, or dual tree, or local dual tree)
e. block location
f. colour component

8. In one example, information related to DCCIP_MODE (e.g., whether the method is applied) may be signalled as a syntax element.
a. In one example, the information related to DCCIP_MODE for two chroma components such as Cb and Cr may be signaled as one syntax element, or may be signaled as two syntax elements.
   i. In one example, whether to apply DCCIP_MODE on two chroma components such as Cb and Cr may be controlled together, or may be controlled in a separate way.
a. In one example, the syntax element may be binarized with fixed length coding, or truncated unary coding, or unary coding, or EG coding, or coded a flag.
b. In one example, the syntax element may be bypass coded.
c. Alternatively, the syntax element may be context coded.
   i. The context may depend on coding information.
      1) In one example, the coding information may refer to block width or/and block height, denoted as BW and BH.
         a) In one example, different contexts may be used when BW×BH≤T₁ and BW×BH>T₁.
         b) In one example, different contexts may be used when BW/BH≤T₂ and BW/BH>T₂.
      2) In one example, the coding information may refer to a slice type.
      3) In one example, the coding information may refer to that information from one or more neighbouring blocks.
         a) In one example, the neighbouring blocks may refer to left, or/and above, or/and left-below, or/and right-above, or/and left-above block.
         b) In one example, the coding information may refer to whether the neighbouring blocks are intra coded.
         c) In one example, the coding information may refer to whether the neighbouring blocks are coded using DCCIP_MODE.
      4) In one example, the coding information may refer to the partition information (e.g., dual or single tree, local dual tree or single tree).
d. In one example, the syntax element may be signalled before or after the indication of colour space conversion, or indication of conventional intra prediction modes, or indication of CCIP (e.g., CCLM and/or MMLM).
e. Whether the syntax element is signalled may depend on coding information.
   i. In one example, the coding information may refer to block dimensions or/and block shape. Denote block width and block height as BW and BH.
      a) In one example, the syntax element may be not signalled when BW×BH≤T₁.
      b) Alternatively, the syntax element may be not signalled when BW×BH>T₁.
      c) In one example, the syntax element may be not signalled when BW/BH≤T₂.
      d) Alternatively, the syntax element may be not signalled when BW/BH>T₂.
   ii. In one example, the coding information may refer to slice/picture types.
   iii. In one example, the coding information may refer to prediction mode (e.g., IBC, palette mode) and/or intra coding tools (e.g., MRL, ISP, MIP, DIMD, TIMD, CCLM, MMLM).
   iv. In one example, when the syntax element is not signalled, it may be inferred to 1.
      1) Alternatively, the syntax element may be inferred to 0.
f. In one example, when none of templates is available to derive the CCIP mode, DCCIP_MODE cannot be applied to the block.
   i. In one example, the information related to DCCIP_MODE is not signalled when none of templates is available.
   ii. In one example, when the reference samples of the template are unavailable to derive the mode, DCCIP_MODE cannot be applied to the block.
   iii. In one example, the information related to DCCIP_MODE is not signalled when the reference samples of the template are unavailable.
   iv. “samples are unavailable” may refer to all samples under consideration are unavailable or at least one of the samples under consideration is unavailable.
g. In one example, whether a block is allowed to be coded with DCCIP_MODE may depend on one or more syntax elements.
   i. In one example, the one or more syntax elements may be signalled as general constraints information.
      1) In one example, when a syntax element (e.g., gci_no_dccip_constraint_flag or gci_no_dccip_constraint_flag) indicating general constraint on DCCIP_MODE is equal to X (e.g., X=0 or X=1), DCCIP_MODE shall be not allowed.
   ii. In one example, the one or more syntax elements may be signalled at sequence header/picture header/SPS/VPS/DPS/DCI/PPS/APS/slice header/tile group header.

9. Whether to and/or how to apply the disclosed methods above may be signalled at sequence level/group of pictures level/picture level/slice level/tile group level, such as in sequence header/picture header/SPS/VPS/DPS/DCI/PPS/APS/slice header/tile group header.

10. Whether to and/or how to apply the disclosed methods above may be signalled at PB/TB/CB/PU/TU/CU/VPDU/CTU/CTU row/slice/tile/sub-picture/other kinds of region contains more than one sample or pixel.

11. Whether to and/or how to apply the disclosed methods above may be dependent on coded information, such as block size, colour format, single/dual tree partitioning, colour component, slice/picture type.

12. The proposed methods disclosed in this document may be used to generate intra prediction in other coding tools which require an intra prediction signal (e.g., the CIIP mode).

The embodiments of the present disclosure are related to mode derivation for cross component intra prediction. As used herein, the term “cross component intra prediction (CCIP)” may refer to a coding method that uses samples in a first component to derive the predicted/reconstructed samples of a second component (e.g., by using a linear model). The first component may refer to luma component and the second component may refer to chroma components. For example, CCIP may refer to CCLM or MMLM. The term “training samples” may refer to samples used to derive the parameters of a model (e.g., linear model) in CCIP. It should be understood that “reference samples” and “training samples” may be used interchangeably in this disclosure. Moreover, “training samples” of a region (e.g., a block or a template) may refer to samples used to derive the parameters of a model for CCIP which is used to further derive the predicted samples of the region. In addition, a neighbouring sample is “unavailable” if it is located in a different video processing unit (e.g., out of the current picture, or current sub-picture, or current tile, or current slice, or current brick, or current CTU, or current processing unit, or any other current video unit) or has not been reconstructed. Furthermore, the term “block” may represent a coding tree block (CTB), a coding tree unit (CTU), a coding block (CB), a coding unit (CU), a prediction unit (PU), a transform unit (TU), a prediction block (PB), a transform block (TB), a video processing unit comprising multiple samples/pixels, and/or the like. A block may be rectangular or non-rectangular.

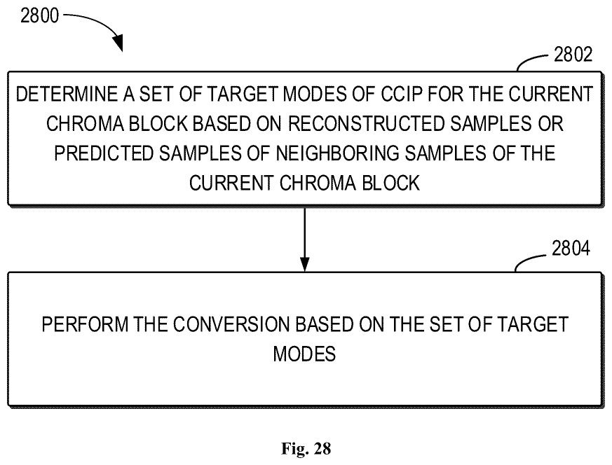

FIG. 28 illustrates a flowchart of a method 2800 for video processing in accordance with some embodiments of the present disclosure. The method 2800 may be implemented during a conversion between a current chroma block of a video and a bitstream of the video. As shown in FIG. 28, the method 2800 starts at 2802 where a set of target modes of CCIP for the current chroma block is determined based on reconstructed samples or predicted samples of neighboring samples of the current chroma block. By way of example, with reference to FIG. 25, reconstructed samples of two templates 2520 and 2522 may be used to determine a set of target modes of CCIP for the current chroma block 2510. Alternatively, the set of target modes of CCIP for the current chroma block 2510 may also be determined based on predicted samples of the two templates 2520 and 2522.

At 2804, the conversion is performed based on the set of target modes. For example, in case that the set of target modes comprise only one target mode, this target mode may be used directly to determine predicted samples of the current chroma block 2510, which may be further used for performing the conversion. In some embodiments, the conversion may include encoding the current chroma block into the bitstream. Alternatively or additionally, the conversion may include decoding the current chroma block from the bitstream. It should be understood that the above illustrations with reference to FIG. 25 are described merely for purpose of description. The scope of the present disclosure is not limited in this respect.

According to the method 2800, the set of target modes of CCIP are derived based on reconstructed samples or predicted samples of neighboring samples of the current block, rather than being signaled in the bitstream. Thereby, compared with the conventional solution, the proposed method can advantageously improve coding efficiency and reduce the coding bits while maintaining the coding quality.

In some embodiments, at 2802, the set of target modes may be determined further based on residual information of the neighboring samples. For example, with reference to FIG. 25, predicted samples and residual information of the two templates 2520 and 2522 may be used to determine reconstructed samples of the two templates 2520 and 2522, which may be further used for determining the set of target modes. It should be understood that the above illustrations with reference to FIG. 25 are described merely for purpose of description. The scope of the present disclosure is not limited in this respect.

In some embodiments, the neighboring samples may be in the same color component of the current chroma block. For example, the neighboring samples may be in the chroma component Cb of the current chroma block. Alternatively, the neighboring samples may be in different color components of the current chroma block. For example, part of the neighboring samples may be in the chroma component Cb of the current chroma block, while the remaining of the neighboring samples may be in the chroma component Cr of the current chroma block. It should be understood that the above illustrations are described merely for purpose of description. The scope of the present disclosure is not limited in this respect.

In some embodiments, at 2802, the set of target modes are determined based on a template. The template may comprise the reconstructed samples of the neighboring samples. By way of example, with reference to FIG. 25, reconstructed samples of the two templates 2520 and 2522 may be used to determine a set of target modes of CCIP for the current chroma block 2510.

In some embodiments, at 2802, a CCIP mode candidate list may be constructed for the current chroma block. In one example, the CCIP mode candidate list may comprise a LM mode of cross-component linear model (CCLM), a LM_T mode of CCLM, a LM_L mode of CCLM, a MMLM mode of multi-model linear model (MMLM), a MMLM_T mode of MMLM, a MMLM_L mode of MMLM, and/or the like. The set of target modes may be determined from the CCIP mode candidate list based on the template. By way of example, costs for at least part of the modes in the CCIP mode candidate list may be determined based on the template. The set of target modes may be determined from the CCIP mode candidate list based on the costs. In one example, a mode with the minimum cost in the CCIP mode candidate list may e determined to be a first target mode in the set of target modes.

In some embodiments, at 2802, for determining a first cost of the costs, a set of parameters for a model of a first mode in the CCIP mode candidate list may be determined based on training samples of the template. Predicted samples of the template may be determined based on the set of parameters and corresponding samples of the template. The corresponding samples may be in a color component different from the template. The first cost for the first mode may be determined based on the predicted samples of the template and reconstructed samples of the template.

In some embodiments, the CCIP may comprise cross-component linear model (CCLM) and/or multi-model linear model (MMLM). Furthermore, the set of target modes may comprise at least one of a LM mode of CCLM, a LM_T mode of CCLM, a LM_L mode of CCLM, a MMLM mode of MMLM, a MMLM_T mode of MMLM, or a MMLM_L mode of MMLM.

In some embodiments, whether to use CCLM or MMLM may be absent from the bitstream. Alternatively or additionally, a mode of CCLM or MMLM to be used may also be absent from the bitstream.

In some embodiments, a first mode in the CCIP mode candidate list may be indicated in the bitstream. Alternatively, a first mode in the CCIP mode candidate list may be absent from the bitstream. In one example, MMLM with at least three categories may be absent from the bitstream and may be determined at the decoder side.

In some embodiments, parameters for the first mode may be determined based on training samples different from a second mode in the CCIP mode candidate list. The second mode is indicated in the bitstream. Alternatively, the parameters for the first mode may be determined in a different manner from the second mode.

In some embodiments, a template used to determine the set of target modes may comprise at least one of reconstructed samples adjacent to the current chroma block or reconstructed samples non-adjacent to the current chroma block. In one example, the template used to determine the set of target modes may comprise at least one of the following: neighboring left-above reconstructed samples (e.g., a template 2430 in FIG. 24J) of the current chroma block, neighboring left reconstructed samples (e.g., a template 2433 in FIG. 24J) of the current chroma block, neighboring above reconstructed samples (e.g., a template 2431 in FIG. 24J) of the current chroma block, neighboring left-below reconstructed samples (e.g., a template 2434 in FIG. 24J) of the current chroma block, or neighboring right-above reconstructed samples (e.g., a template 2432 in FIG. 24J) of the current chroma block. In one example, the template may be non-adjacent to the current chroma block.

In some embodiments, a shape of the template may be pre-defined. Alternatively, the shape of the template may be indicated in the bitstream. In some other embodiments, the shape of the template may be dependent on coding information of the current chroma block. In some embodiments, a size of the template may be pre-defined. Alternatively, the size of the template may be indicated in the bitstream. In some other embodiments, the size of the template may be dependent on coding information of the current chroma block. In some embodiments, dimensions of the template may be pre-defined. Alternatively, the dimensions of the template may be indicated in the bitstream. In some other embodiments, the dimensions of the template may be dependent on coding information of the current chroma block.

In some embodiments, the coding information may comprise dimensions of the current chroma block. In one example, a width of the template may be dependent on a width of the current chroma block and/or a height of the current chroma block. Additionally or alternatively, a height of the template may be dependent on a width of the current chroma block and/or a height of the current chroma block. By way of example, the width or the height of the template may be determined by adjusting the width or the height of the current chroma block with a scale factor. In one example, the scale factor may be dependent on the width or the height of the current chroma block. Alternatively, the scale factor may be indicated in the bitstream. In a further example, the scale factor may be pre-defined.

In some embodiments, a size of the template may be dependent on whether part of samples or all of the samples in the template are available. Additionally or alternatively, dimensions of the template may be dependent on whether part of samples or all of the samples in the template are available.

In some embodiments, a first set of training samples for determining parameters for a model of a first mode of CCIP for the template may be the same as a second set of training samples for determining parameters for the model for the current chroma block. That is, the same set of training samples may be used for both the template and the current chroma block. Thereby, the model determined based on the training samples can be advantageously more accurate for the current chroma block, and thus the coding quality may be improved. In some embodiments, the first set of training samples may be determined in the same manner as the second set of training samples.

In some embodiments, the first set of training samples may comprise adjacent above reconstructed samples and adjacent left reconstructed samples of the current chroma block. For example, the first set of training samples may be used to determine parameters for CCIP mode. In some further embodiments, the first set of training samples may comprise adjacent left reconstructed samples and adjacent left-below reconstructed samples of the current chroma block. For example, the first set of training samples may be used to determine parameters for CCIP_L mode. Alternatively, the first set of training samples may comprise adjacent above reconstructed samples and adjacent right-above reconstructed samples of the current chroma block. For example, the first set of training samples may be used to determine parameters for CCIP_T mode.

In some embodiments, a shape of the template may be the same as a shape of the current chroma block. Additionally or alternatively, a size of the template may be the same as a size of the current chroma block. In some additional or alternative embodiments, the number of training samples in the first set may be the same as the number of training samples in the second set.

In some embodiments, the first set of training samples may comprise one row of training samples. Additionally or alternatively, the first set of training samples may comprise one column of training samples.

In some embodiments, the first set of training samples may be different from a third set of training samples for determining parameters for a model of a second mode of CCIP for the template. That is, different sets of training samples may be used for different CCIP modes. In one example, adjacent above reconstructed samples and adjacent left reconstructed samples of the current chroma block may be used for CCIP mode. In another example, adjacent above reconstructed samples and adjacent right-above reconstructed samples of the current chroma block may be used for CCIP_T mode. In yet another example, adjacent left reconstructed samples and adjacent left-below reconstructed samples of the current chroma block may be used for CCIP_L mode. It should be understood that the above illustrations and/or examples are described merely for purpose of description. The scope of the present disclosure is not limited in this respect.

In some embodiments, a width of right-above training samples in the first set may be dependent on a width of the current chroma block, a height of the current chroma block, and/or the number of available right-above training samples. In one example, the width of right-above training samples may be equal to a smaller value among the height of the current chroma block and the number of available right-above training samples. Alternatively, the width of right-above training samples may be equal to a smaller value among the width of the current chroma block and the number of available right-above training samples. In another example, the width of right-above training samples may be equal to the number of available right-above training samples. In yet another example, the width of right-above training samples may be equal to the width of the current chroma block. In a further example, the width of right-above training samples may be equal to the height of the current chroma block. It should be understood that the above illustrations and/or examples are described merely for purpose of description. The scope of the present disclosure is not limited in this respect.

In some embodiments, a height of left-below training samples in the first set may be dependent on a width of the current chroma block, a height of the current chroma block, and/or the number of available left-below training samples. In one example, the height of left-below training samples may be equal to a smaller value among the height of the current chroma block and the number of available left-below training samples. Alternatively, the height of left-below training samples may be equal to a smaller value among the width of the current chroma block and the number of available left-below training samples. In another example, the height of left-below training samples may be equal to the number of available left-below training samples. In yet another example, the height of left-below training samples may be equal to the width of the current chroma block. In a further example, the height of left-below training samples may be equal to the height of the current chroma block. It should be understood that the above illustrations and/or examples are described merely for purpose of description. The scope of the present disclosure is not limited in this respect.

In some embodiments, a first set of training samples for determining parameters for a model of a first mode of CCIP for the template may be different from a second set of training samples for determining parameters for the model for the current chroma block. That is, different sets of training samples may also be used for the template and the current chroma block.

In some embodiments, the first set of training samples may comprise a plurality of rows of training samples. Additionally or alternatively, the first set of training samples may comprise a plurality of columns of training samples. In one example, as shown in FIG. 26A, the first set of training samples may comprise reconstructed samples at a left side of the template and reconstructed samples above the template. In another example, as shown in FIG. 26B, the first set of training samples may comprise reconstructed samples at a left side of the template. In yet another example, as shown in FIG. 26C, the first set of training samples may comprise reconstructed samples above the template. It should be understood that the above illustrations and/or examples are described merely for purpose of description. The scope of the present disclosure is not limited in this respect.

In some embodiments, as shown in FIG. 27A and FIG. 27C, part of training samples in the first set may be in the template. In some other embodiments, as shown in FIG. 27B, all of training samples in the first set may be in the template.

In some embodiments, parameters for a model of a mode of CCIP for the template may be determined in the same manner as parameters for the model for the current chroma block. Alternatively, parameters for the model for the template may be determined in a different manner from parameters for the model for the current chroma block. In one example, a Min-Max process may be used to determine the parameters for the model for the template, if a linear model is used in CCIP for the current chroma block. In another example, a Least-Mean-Square (LMS) process may be used to determine the parameters for the model for the template, if a linear model is used in CCIP for the current chroma block.

In some embodiments, information on how to determine the parameters for the model for the template may be indicated in the bitstream. Alternatively, information on how to determine the parameters for the model for the template may be pre-defined. In some other embodiments, information on how to determine the parameters for the model for the template may be dependent on coding information of the current chroma block or a set of neighboring blocks of the current chroma block.

In some embodiments, the first cost for the first mode in the CCIP mode candidate list may be determined based on an error metric between the predicted samples and the reconstructed samples of the template. The error metric may indicate a distortion between the predicted samples and the reconstructed samples. By way of example, the error metric may be a sum of the absolute transformed difference (SATD), a sum of the squared errors (SSE), a sum of the absolute difference (SAD), a mean removal sum of the absolute difference (MRSAD), a subjective quality metric (e.g. the structural similarity index measure (SSIM)), or the like.

In some embodiments, an error item and a regulation item may be determined. The error item may indicate a distortion between the predicted samples and the reconstructed samples of the template. The regulation item may indicate the number of bits for coding information of the template. The first cost may be determined based on a weighted sum of the error item and the regulation item. In one example, a weight for the regulation item may be predefined. Alternatively, the weight for the regulation item may be determined on-the-fly.

In some embodiments, the first cost may be determined based on part of samples of the template. Alternatively, the first cost may be determined based on all of samples of the template.

In some embodiments, a second cost of a first chroma component of the current chroma block and a third cost of a second chroma component of the current chroma block may be determined. The first cost may be determined based on the second cost and the third cost. In one example, a sum of the second cost and the third cost may be determined as the first cost. More specifically, a weighted sum of the second cost and the third cost may be determined as the first cost. For example, a sum of a weight for the second cost and a weight for the third cost may be equal to a predetermined value, such as 1. It should be understood that the above illustrations and/or examples are described merely for purpose of description. The scope of the present disclosure is not limited in this respect.

In some other embodiments, a weighted sum of the second cost and the third cost may be determined. The weighted sum is adjusted with an offset to obtain an offset. A shift operation is performed on the offset sum to obtain the first cost. In one example, at least one parameter used for determining the first cost may be indicated in the bitstream. Alternatively, the at least one parameter may be pre-defined. In another example, the at least one parameter may be determined on-the-fly. In yet another example, the at least one parameter may be dependent on coding information of the current chroma block or a set of neighboring blocks of the current chroma block.

In some embodiments, the set of target modes may comprise a first subset of target modes for a first chroma component of the current chroma block and a second subset of target modes for a second chroma component of the current chroma block. The first subset and the second subset may be determined individually. In one example, the first subset of target modes may be determined in a different manner from the second subset of target modes. Alternatively, the first subset of target modes may be determined in the same manner as the second subset of target modes. In another example, the first subset of target modes may be different from the second subset of target modes. Alternatively, the first subset of target modes may be the same as the second subset of target modes.

In some embodiments, at 2804, predicted samples or reconstructed samples of at least one color component of the current chroma block may be determined based on the set of target modes of CCIP. The conversion may be performed based on the predicted samples or the reconstructed samples of the at least one color component. In one example, the at least one color component may comprise Cb and/or Cr.

In some embodiments, the at least one color component may comprise a first color component of the current chroma block. Predicted samples or reconstructed samples of a second color component of the current chroma block may be determined based on one of a further mode of CCIP, a planar mode, a DC mode, a horizontal mode, a vertical mode, or a vertical diagonal mode. The conversion may be performed based on the predicted samples or the reconstructed samples of the first and second color component. In one example, the further mode may be indicated in the bitstream. Alternatively, the further mode may be pre-defined.

In some embodiments, the set of target modes may comprise a plurality of target modes. In one example, the target mode used for the conversion may be indicated in the bitstream. In another example, the target mode used for the conversion may be determined on-the-fly. In yet another example, the target mode used for the conversion may be dependent on coding information of the current chroma block or a set of neighboring blocks of the current chroma block.

In some embodiments, at 2804, a plurality of predicted signals for the current chroma block may be determined based on a plurality of IPMs. A final prediction of the current chroma block may be determined based on the plurality of predicted signals. The conversion may be performed based on the final prediction. For example, the plurality of IPMs may comprise the set of target modes, a further mode of CCIP, and/or a target IPM. In one example, the further mode of CCIP may be pre-defined. In another example, the further mode of CCIP may be indicated in the bitstream. Additionally or alternatively, the target IPM may be predefined. In yet another example, the target IPM may be indicated in the bitstream. By way of example, the further mode of CCIP may be a cross-component prediction mode. In addition, the target IPM may be a planar mode, a DC mode, a horizontal mode, a vertical mode, a diagonal mode, a vertical diagonal mode, or the like. It should be understood that the above illustrations and/or examples are described merely for purpose of description. The scope of the present disclosure is not limited in this respect.

In some embodiments, final predictions of chroma components of the current chroma block may be determined in different manners. That is, different fusion methods may be applied, in which different fusion methods may refer to use different modes (e.g., CCIP modes and/or a planar mode, etc.) and/or different weighted factors in the fusion.

In some embodiments, a weighted sum of the plurality of predicted signals may be determined to obtain the final prediction. A weight for a predicted signal of the plurality of predicted signals may be dependent on a cost of a mode for determining the predicted signal.

In some embodiments, at least one of the following may be indicated in the bitstream: whether to determine a final prediction of the current chroma block based on a plurality of predicted signals for the current chroma block, information on how to determine the final prediction based on the plurality of predicted signals, the number of modes used, or an indication of determining the final prediction based on the plurality of predicted signals.

In some alternative embodiments, at least one of the following may be determined on-the-fly: whether to determine a final prediction of the current chroma block based on a plurality of predicted signals for the current chroma block, information on how to determine the final prediction based on the plurality of predicted signals, the number of modes used, or an indication of determining the final prediction based on the plurality of predicted signals.

In some alternative embodiments, at least one of the following may be dependent on coding information of the current chroma block or a set of neighboring blocks of the current chroma block: whether to determine a final prediction of the current chroma block based on a plurality of predicted signals for the current chroma block, information on how to determine the final prediction based on the plurality of predicted signals, the number of modes used, or an indication of determining the final prediction based on the plurality of predicted signals.

In some embodiments, at least one of the following may be dependent on costs of the modes: whether to determine a final prediction of the current chroma block based on a plurality of predicted signals for the current chroma block, or information on how to determine the final prediction based on the plurality of predicted signals. In one example, the final prediction may be determined based on the plurality of predicted signals, if a ratio of the second smallest cost to the smallest cost is less than a predetermined value.

In some embodiments, whether a target chroma block of the video is coded with a decoder-side derivation of CCIP (DCCIP) may be determined on-the-fly. In one example, the target chroma block may be determined to be coded with DCCIP, if the target chroma block is not coded with a linear model mode. In another example, the target chroma block may be determined to be coded with DCCIP, if the target chroma block is not coded with a planar mode, a DC mode, a horizontal mode, a vertical mode, a vertical diagonal mode and a chroma DM mode. In some alternative embodiments, whether a target chroma block of the video is coded with DCCIP may be determined based on whether CCIP is allowed, block dimensions, a block size, a block depth, a slice type, a picture type, a partition tree type, a block location, a color component, or the like.

In some embodiments, information on DCCIP may be indicated as a set of syntax elements in the bitstream. In one example, information on DCCIP for chroma components of the current chroma block may be indicated in the bitstream by one syntax element of the set of syntax elements. Alternatively, information on DCCIP for chroma components may be indicated in the bitstream by a plurality of syntax elements of the set of syntax elements. In another example, whether the chroma components are coded with DCCIP may be dependent on the one syntax element. In yet another example, whether the chroma components are coded with DCCIP may be dependent on the plurality of syntax elements respectively.

In some embodiments, the set of syntax elements may be coded as a flag. Alternatively, the set of syntax elements may be binarized with fixed length coding. In another embodiment, the set of syntax elements may be binarized with truncated unary coding. In a further embodiment, the set of syntax elements may be binarized with unary coding. In yet another embodiment, the set of syntax elements may be binarized with exponential Golomb (EG) coding.

In some embodiments, the set of syntax elements may be bypass coded. In some alternative embodiments, the set of syntax elements may be context coded. By way of example, a context for context coding of the set of syntax elements may be dependent on coding information of the current chroma block or a set of neighboring blocks of the current chroma block. For example, the set of neighboring blocks may comprise a left block of the current chroma block, an above block of the current chroma block, a left-below block of the current chroma block, a right block of the current chroma block, and/or a left-above block of the current chroma block. In one example, the coding information may comprise a block width and/or a block height.

In some embodiments, a first context may be used for the context coding if a product of the block width and the block height is smaller than or equal to a threshold, and a second context may be used for context coding if the product of the block width and the block height is larger than the threshold. The second context may be different from the first context.

In some embodiments, a first context may be used for the context coding if a ratio of the block width to the block height is smaller than or equal to a threshold, and a second context may be used for context coding if the ratio of the block width to the block height is larger than the threshold. The second context may be different from the first context.

In some embodiments, the coding information may comprise a slice type. Additionally or alternatively, the coding information may comprise whether the set of neighboring blocks are intra coded. In some additional or alternative embodiments, the coding information may comprise whether the set of neighboring blocks are coded with DCCIP. Additionally or alternatively, the coding information may comprise partition information of the current chroma block or the set of neighboring blocks.

In some embodiments, the set of syntax elements may be indicated in the bitstream before an indication of color space conversion. Alternatively, the set of syntax elements may be indicated in the bitstream after an indication of color space conversion. In another example, the set of syntax elements may be indicated in the bitstream before an indication of CCLM. Alternatively, the set of syntax elements may be indicated in the bitstream after an indication of CCLM. In another example, the set of syntax elements may be indicated in the bitstream before an indication of MMLM. Alternatively, the set of syntax elements may be indicated in the bitstream after an indication of MMLM. In another example, the set of syntax elements may be indicated in the bitstream before an indication of a planar mode. Alternatively, the set of syntax elements may be indicated in the bitstream after an indication of a planer mode. In another example, the set of syntax elements may be indicated in the bitstream before an indication of a DC mode. Alternatively, the set of syntax elements may be indicated in the bitstream after an indication of a DC mode. In another example, the set of syntax elements may be indicated in the bitstream before an indication of a horizontal mode. Alternatively, the set of syntax elements may be indicated in the bitstream after an indication of a horizontal mode. In another example, the set of syntax elements may be indicated in the bitstream before an indication of a vertical mode. Alternatively, the set of syntax elements may be indicated in the bitstream after an indication of a vertical mode. In another example, the set of syntax elements may be indicated in the bitstream before an indication of a vertical diagonal mode. Alternatively, the set of syntax elements may be indicated in the bitstream after an indication of a vertical diagonal mode.

In some embodiments, whether a set of syntax elements indicating information on DCCIP are indicated in the bitstream may be dependent on coding information of the current chroma block or a set of neighboring blocks of the current chroma block. By way of example, the coding information may comprise a block width and/or a block height. In one example, the set of syntax elements may be absent from the bitstream if a product of the block width and the block height is smaller than or equal to a first threshold. Alternatively, the set of syntax elements may be absent from the bitstream if a product of the block width and the block height is larger than a second threshold. In another example, the set of syntax elements may be absent from the bitstream if a ratio of the block width to the block height is smaller than or equal to a third threshold. Alternatively, the set of syntax elements may be absent from the bitstream if a ratio of the block width to the block height is larger than a fourth threshold.

In some embodiments, the coding information may comprise a slice type or a picture type. Additionally or alternatively, the coding information may comprise a prediction mode and/or an intra coding tool.

In some embodiments, the set of syntax elements may be determined to be a predefined value if the set of syntax elements are absent from the bitstream. For example, the predefined value may be equal to 1 or 0. It should be understood that the above illustrations and/or examples are described merely for purpose of description. The scope of the present disclosure is not limited in this respect.

In some embodiments, a target chroma block of the video may be coded with a coding tool other than DCCIP, if templates of the target chroma block are unavailable. In one example, information on applying DCCIP to a target chroma block of the video may be absent from the bitstream, if templates of the target chroma block are unavailable. In another example, a target chroma block of the video may be coded with a coding tool other than DCCIP, if at least one training samples of a template of the target chroma block is unavailable. In yet another example, information on applying DCCIP to a target chroma block of the video may be absent from the bitstream, if at least one training samples of a template of the target chroma block is unavailable.

In some embodiments, whether a target chroma block of the video is allowed to be coded with DCCIP may be dependent on a set of syntax elements. For example, the set of syntax elements may be indicated in the bitstream as general constraints information. In one example, the target chroma block may be not allowed to be coded with DCCIP, if a syntax element of the set of syntax elements indicates general constrain on DCCIP being equal to a predetermined value. By way of example, the predetermined value may be equal to 1 or 0. It should be understood that the above illustrations and/or examples are described merely for purpose of description. The scope of the present disclosure is not limited in this respect.

In some embodiments, the set of syntax elements may be included in a sequence header. Alternatively, the set of syntax elements may be included in a picture header. In another embodiment, the set of syntax elements may be included in a sequence parameter set (SPS). Alternatively, the set of syntax elements may be included in a video parameter set (VPS). In yet another embodiment, the set of syntax elements may be included in a dependency parameter set (DPS). Alternatively, the set of syntax elements may be included in a decoding capability information (DCI). In a further embodiment, the set of syntax elements may be included in a picture parameter set (PPS) or an adaptation parameter sets (APS). Alternatively, the set of syntax elements may be included in a slice header or a tile group header.

In some embodiments, whether to and/or how to apply the method according to some embodiments of the present disclosure may be indicated at one of: a sequence level, a group of pictures level, a picture level, a slice level, or a tile group level.

In some embodiments, whether to and/or how to apply the method according to some embodiments of the present disclosure may be indicated in one of: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header. Additionally or alternatively, how to apply the method according to some embodiments of the present disclosure may be indicated in one of: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

In some embodiments, whether to and/or how to apply the method according to some embodiments of the present disclosure may be indicated at one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel. Additionally or alternatively, how to apply the method according to some embodiments of the present disclosure may be indicated at one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel

In some embodiments, the method according to some embodiments of the present disclosure may further comprise: determining, based on coded information of the current video unit, whether to and/or how to apply the method according to some embodiments of the present disclosure. The coded information may comprise at least one of: a block size, a color format, a single dual tree partitioning, a dual tree partitioning, a color component, a slice type, a picture type, or the like. It should be understood that the above illustrations and/or examples are described merely for purpose of description. The scope of the present disclosure is not limited in this respect.

In some embodiments, the method according to some embodiments of the present disclosure may be used in other coding tools requiring an intra prediction signal to determine intra prediction.

In some embodiments, a bitstream of a video may be stored in a non-transitory computer-readable recording medium. The bitstream of the video can be generated by a method performed by a video processing apparatus. According to the method, a set of target modes of CCIP for a current chroma block of the video may be determined based on reconstructed samples or predicted samples of neighboring samples of the current chroma block. Moreover, the bitstream may be generated based on the set of target modes.

In some embodiments, a set of target modes of CCIP for a current chroma block of the video may be determined based on reconstructed samples or predicted samples of neighboring samples of the current chroma block. Moreover, the bitstream may be generated based on the set of target modes. The bitstream may be stored in a non-transitory computer-readable recording medium.

Implementations of the present disclosure can be described in view of the following clauses, the features of which can be combined in any reasonable manner.

Clause 1. A method for video processing, comprising: determining, during a conversion between a current chroma block of a video and a bitstream of the video, a set of target modes of cross component intra prediction (CCIP) for the current chroma block based on reconstructed samples or predicted samples of neighboring samples of the current chroma block; and performing the conversion based on the set of target modes.

Clause 2. The method of clause 1, wherein the set of target modes are determined further based on residual information of the neighboring samples.

Clause 3. The method of clause 1, wherein the neighboring samples are in the same color component of the current chroma block, or the neighboring samples are in different color components of the current chroma block.

Clause 4. The method of any of clauses 1-3, wherein determining the set of target modes comprises: determining the set of target modes based on a template comprising the reconstructed samples of the neighboring samples.

Clause 5. The method of clause 4, wherein determining the set of target modes based on the template comprises: constructing a CCIP mode candidate list for the current chroma block; and determining the set of target modes from the CCIP mode candidate list based on the template.

Clause 6. The method of clause 5, wherein the CCIP mode candidate list comprises at least one of: a LM mode of cross-component linear model (CCLM), a LM_T mode of CCLM, a LM_L mode of CCLM, a MMLM mode of multi-model linear model (MMLM), a MMLM_T mode of MMLM, or a MMLM_L mode of MMLM.

Clause 7. The method of any of clauses 5-6, wherein determining the set of target modes from the CCIP mode candidate list based on the template comprises: determining costs for part of or all of modes in the CCIP mode candidate list based on the template; and determining the set of target modes from the CCIP mode candidate list based on the costs.

Clause 8. The method of clause 7, wherein determining the set of target modes from the CCIP mode candidate list based on the costs comprises: determining a mode with the minimum cost in the CCIP mode candidate list to be a first target mode in the set of target modes.

Clause 9. The method of any of clauses 7-8, wherein determining the costs comprises: determining a set of parameters for a model of a first mode in the CCIP mode candidate list based on training samples of the template; determining predicted samples of the template based on the set of parameters and corresponding samples of the template, the corresponding samples being in a color component different from the template; and determining a first cost for the first mode based on the predicted samples of the template and reconstructed samples of the template.

Clause 10. The method of any of clauses 1-9, wherein the CCIP comprises at least one of: cross-component linear model (CCLM), or multi-model linear model (MMLM).

Clause 11. The method of clause 10, wherein the set of target modes comprises at least one of: a LM mode of CCLM, a LM_T mode of CCLM, a LM_L mode of CCLM, a MMLM mode of MMLM, a MMLM_T mode of MMLM, or a MMLM_L mode of MMLM.

Clause 12. The method of any of clauses 10-11, wherein at least one of the following is absent from the bitstream: whether to use CCLM or MMLM, a mode of CCLM to be used, or a mode of MMLM to be used.

Clause 13. The method of any of clauses 5-9, wherein a first mode in the CCIP mode candidate list is indicated in the bitstream.

Clause 14. The method of any of clauses 5-9, wherein a first mode in the CCIP mode candidate list is absent from the bitstream.

Clause 15. The method of clause 14, wherein the first mode is MMLM with at least three categories.

Clause 16. The method of clause 14, wherein parameters for the first mode are determined based on training samples different from a second mode in the CCIP mode candidate list, the second mode being indicated in the bitstream, or the parameters for the first mode are determined in a different manner from the second mode.

Clause 17. The method of any of clauses 1-16, wherein a template used to determine the set of target modes comprises at least one of: reconstructed samples adjacent to the current chroma block, or reconstructed samples non-adjacent to the current chroma block.

Clause 18. The method of any of clauses 1-16, wherein a template used to determine the set of target modes comprises at least one of: neighboring left-above reconstructed samples of the current chroma block, neighboring left reconstructed samples of the current chroma block, neighboring above reconstructed samples of the current chroma block, neighboring left-below reconstructed samples of the current chroma block, or neighboring right-above reconstructed samples of the current chroma block.

Clause 19. The method of clause 18, wherein the template is non-adjacent to the current chroma block.

Clause 20. The method of any of clauses 17-19, wherein a shape of the template is pre-defined, or the shape of the template is indicated in the bitstream, or the shape of the template is dependent on coding information of the current chroma block, or a size of the template is pre-defined, or the size of the template is indicated in the bitstream, or the size of the template is dependent on coding information of the current chroma block, or dimensions of the template are pre-defined, or the dimensions of the template are indicated in the bitstream, or the dimensions of the template are dependent on coding information of the current chroma block.

Clause 21. The method of clause 20, wherein the coding information comprises dimensions of the current chroma block.

Clause 22. The method of any of clauses 17-21, wherein a width or a height of the template is dependent on at least one of: a width of the current chroma block, or a height of the current chroma block.

Clause 23. The method of clause 22, wherein the width or the height of the template is determined by adjusting the width or the height of the current chroma block with a scale factor.

Clause 24. The method of clause 23, wherein the scale factor is dependent on the width or the height of the current chroma block, or the scale factor is indicated in the bitstream, or the scale factor is pre-defined.

Clause 25. The method of any of clauses 17-24, wherein at least one of the following is dependent on whether part of samples or all of the samples in the template are available: a size of the template, or dimensions of the template.

Clause 26. The method of any of clauses 4-25, wherein a first set of training samples for determining parameters for a model of a first mode of CCIP for the template are the same as a second set of training samples for determining parameters for the model for the current chroma block.

Clause 27. The method of clause 26, wherein the first set of training samples are determined in the same manner as the second set of training samples.

Clause 28. The method of any of clauses 26-27, wherein the first set of training samples comprise adjacent above reconstructed samples and adjacent left reconstructed samples of the current chroma block.

Clause 29. The method of clause 28, wherein the first mode is CCIP mode.

Clause 30. The method of any of clauses 26-27, wherein the first set of training samples comprise adjacent left reconstructed samples and adjacent left-below reconstructed samples of the current chroma block.

Clause 31. The method of clause 30, wherein the first mode is CCIP_L mode.

Clause 32. The method of any of clauses 26-27, wherein the first set of training samples comprise adjacent above reconstructed samples and adjacent right-above reconstructed samples of the current chroma block.

Clause 33. The method of clause 32, wherein the first mode is CCIP_T mode.

Clause 34. The method of any of clauses 26-33, wherein a shape of the template is the same as a shape of the current chroma block, or a size of the template is the same as a size of the current chroma block, or the number of training samples in the first set is the same as the number of training samples in the second set.

Clause 35. The method of any of clauses 26-34, wherein the first set of training samples comprises one row of training samples or one column of training samples.

Clause 36. The method of any of clauses 26-35, wherein the first set of training samples are different from a third set of training samples for determining parameters for a model of a second mode of CCIP for the template.

Clause 37. The method of clause 36, wherein adjacent above reconstructed samples and adjacent left reconstructed samples of the current chroma block are used for CCIP mode.

Clause 38. The method of clause 36, wherein adjacent above reconstructed samples and adjacent right-above reconstructed samples of the current chroma block are used for CCIP_T mode.

Clause 39. The method of clause 36, wherein adjacent left reconstructed samples and adjacent left-below reconstructed samples of the current chroma block are used for CCIP_L mode.

Clause 40. The method of clause 26, wherein a width of right-above training samples in the first set is dependent on at least one of: a width of the current chroma block, a height of the current chroma block, or the number of available right-above training samples.

Clause 41. The method of clause 40, wherein the width of right-above training samples is equal to a smaller value among the height of the current chroma block and the number of available right-above training samples, or the width of right-above training samples is equal to a smaller value among the width of the current chroma block and the number of available right-above training samples, or the width of right-above training samples is equal to the number of available right-above training samples, or the width of right-above training samples is equal to the width of the current chroma block, or the width of right-above training samples is equal to the height of the current chroma block.

Clause 42. The method of clause 26, wherein a height of left-below training samples in the first set is dependent on at least one of: a width of the current chroma block, a height of the current chroma block, or the number of available left-below training samples.

Clause 43. The method of clause 42, wherein the height of left-below training samples is equal to a smaller value among the height of the current chroma block and the number of available left-below training samples, or the height of left-below training samples is equal to a smaller value among the width of the current chroma block and the number of available left-below training samples, or the height of left-below training samples is equal to the number of available left-below training samples, or the height of left-below training samples is equal to the width of the current chroma block, or the height of left-below training samples is equal to the height of the current chroma block.

Clause 44. The method of any of clauses 4-25, wherein a first set of training samples for determining parameters for a model of a first mode of CCIP for the template are different from a second set of training samples for determining parameters for the model for the current chroma block.

Clause 45. The method of clause 44, wherein the first set of training samples comprise at least one of: a plurality of rows of training samples, or a plurality of columns of training samples.

Clause 46. The method of any of clauses 44-45, wherein the first set of training samples comprise at least one of: reconstructed samples at a left side of the template, or reconstructed samples above the template.

Clause 47. The method of any of clauses 44-45, wherein part of training samples in the first set are in the template, or all of training samples in the first set are in the template.

Clause 48. The method of any of clauses 4-47, wherein parameters for a model of a mode of CCIP for the template are determined in the same manner as parameters for the model for the current chroma block, or parameters for the model for the template are determined in a different manner from parameters for the model for the current chroma block.

Clause 49. The method of clause 48, wherein a Min-Max process is used to determine the parameters for the model for the template, if a linear model is used in CCIP for the current chroma block.

Clause 50. The method of clause 48, wherein a Least-Mean-Square (LMS) process is used to determine the parameters for the model for the template, if a linear model is used in CCIP for the current chroma block.

Clause 51. The method of any of clauses 48-50, wherein information on how to determine the parameters for the model for the template is indicated in the bitstream, or information on how to determine the parameters for the model for the template is pre-defined, or information on how to determine the parameters for the model for the template is dependent on coding information of the current chroma block or a set of neighboring blocks of the current chroma block.

Clause 52. The method of clause 9, wherein determining the first cost comprises: determining the first cost based on an error metric between the predicted samples and the reconstructed samples of the template, the error metric indicating a distortion between the predicted samples and the reconstructed samples.

Clause 53. The method of clause 52, wherein the error metric is one of: a sum of the absolute transformed difference (SATD), a sum of the squared errors (SSE), a sum of the absolute difference (SAD), a mean removal sum of the absolute difference (MRSAD), or a subjective quality metric.

Clause 54. The method of clause 9, wherein determining the first cost comprises: determining an error item indicating a distortion between the predicted samples and the reconstructed samples of the template; determining a regulation item indicating the number of bits for coding information of the template; and determining the first cost based on a weighted sum of the error item and the regulation item.

Clause 55. The method of clause 54, wherein a weight for the regulation item is predefined, or the weight for the regulation item is determined on-the-fly.

Clause 56. The method of any of clauses 52-55, wherein the first cost is determined based on part of samples of the template, or the first cost is determined based on all of samples of the template.

Clause 57. The method of clause 9, wherein determining the first cost comprises: determining a second cost of a first chroma component of the current chroma block; determining a third cost of a second chroma component of the current chroma block; and determining the first cost based on the second cost and the third cost.

Clause 58. The method of clause 57, wherein determining the first cost based on the second cost and the third cost comprises: determining a sum of the second cost and the third cost as the first cost.

Clause 59. The method of clause 57, wherein determining the first cost based on the second cost and the third cost comprises: determining a weighted sum of the second cost and the third cost as the first cost.

Clause 60. The method of clause 59, wherein a sum of a weight for the second cost and a weight for the third cost is equal to a predetermined value.

Clause 61. The method of clauses 57, wherein determining the first cost based on the second cost and the third cost comprises: determining a weighted sum of the second cost and the third cost; obtaining an offset sum by adjusting the weighted sum with an offset; and performing a shift operation on the offset sum to obtain the first cost.

Clause 62. The method of any of clauses 57-61, wherein at least one parameter used for determining the first cost is indicated in the bitstream, or the at least one parameter is pre-defined, or the at least one parameter is determined on-the-fly, or the at least one parameter is dependent on coding information of the current chroma block or a set of neighboring blocks of the current chroma block.

Clause 63. The method of any of clauses 1-62, wherein the set of target modes comprise a first subset of target modes for a first chroma component of the current chroma block and a second subset of target modes for a second chroma component of the current chroma block, the first subset and the second subset being determined individually.

Clause 64. The method of clause 63, wherein the first subset of target modes are determined in a different manner from the second subset of target modes.

Clause 65. The method of clause 63, wherein the first subset of target modes are determined in the same manner as the second subset of target modes.

Clause 66. The method of clause 63, wherein the first subset of target modes are different from the second subset of target modes.

Clause 67. The method of clause 63, wherein the first subset of target modes are the same as the second subset of target modes.

Clause 68. The method of any of clauses 1-67, wherein performing the conversion comprises: determining predicted samples or reconstructed samples of at least one color component of the current chroma block based on the set of target modes of CCIP; and performing the conversion based on the predicted samples or the reconstructed samples of the at least one color component.

Clause 69. The method of clause 68, wherein the at least one color component comprise at least one of Cb or Cr.

Clause 70. The method of clause 68, wherein the at least one color component comprise a first color component of the current chroma block, and performing the conversion based on the predicted samples or the reconstructed samples comprises: determining predicted samples or reconstructed samples of a second color component of the current chroma block based on one of a further mode of CCIP, a planar mode, a DC mode, a horizontal mode, a vertical mode, or a vertical diagonal mode; and performing the conversion based on the predicted samples or the reconstructed samples of the first and second color component.

Clause 71. The method of clause 70, wherein the further mode is indicated in the bitstream, or the further mode is pre-defined.

Clause 72. The method of any of clauses 1-71, wherein the set of target modes comprise a plurality of target modes and the target mode used for the conversion is indicated in the bitstream, or the target mode used for the conversion is determined on-the-fly, or the target mode used for the conversion is dependent on coding information of the current chroma block or a set of neighboring blocks of the current chroma block.

Clause 73. The method of any of clauses 1-72, wherein performing the conversion comprises: determining a plurality of predicted signals for the current chroma block based on a plurality of IPMs; determining a final prediction of the current chroma block based on the plurality of predicted signals; and performing the conversion based on the final prediction.

Clause 74. The method of clause 73, wherein the plurality of IPMs comprise at least one of: the set of target modes, a further mode of CCIP, or a target IPM.

Clause 75. The method of clause 74, wherein the further mode of CCIP is pre-defined, or the further mode of CCIP is indicated in the bitstream, and the target IPM is predefined or the target IPM is indicated in the bitstream.

Clause 76. The method of any of clauses 74-75, wherein the further mode of CCIP is a cross-component prediction mode.

Clause 77. The method of any of clauses 74-76, wherein the target IPM is one of: a planar mode, a DC mode, a horizontal mode, a vertical mode, a diagonal mode, or a vertical diagonal mode.

Clause 78. The method of any of clauses 73-77, wherein final predictions of chroma components of the current chroma block are determined in different manners.

Clause 79. The method of any of clauses 73-77, wherein determining the final prediction comprises: determining a weighted sum of the plurality of predicted signals to obtain the final prediction, a weight for a predicted signal of the plurality of predicted signals being dependent on a cost of a mode for determining the predicted signal.

Clause 80. The method of any of clauses 1-72, wherein at least one of the following is indicated in the bitstream: whether to determine a final prediction of the current chroma block based on a plurality of predicted signals for the current chroma block, information on how to determine the final prediction based on the plurality of predicted signals, the number of modes used, or an indication of determining the final prediction based on the plurality of predicted signals.

Clause 81. The method of any of clauses 1-72, wherein at least one of the following is determined on-the-fly: whether to determine a final prediction of the current chroma block based on a plurality of predicted signals for the current chroma block, information on how to determine the final prediction based on the plurality of predicted signals, the number of modes used, or an indication of determining the final prediction based on the plurality of predicted signals.

Clause 82. The method of any of clauses 1-72, wherein at least one of the following is dependent on coding information of the current chroma block or a set of neighboring blocks of the current chroma block: whether to determine a final prediction of the current chroma block based on a plurality of predicted signals for the current chroma block, information on how to determine the final prediction based on the plurality of predicted signals, the number of modes used, or an indication of determining the final prediction based on the plurality of predicted signals.

Clause 83. The method of any of clauses 1-72, at least one of the following is dependent on costs of the modes: whether to determine a final prediction of the current chroma block based on a plurality of predicted signals for the current chroma block, or information on how to determine the final prediction based on the plurality of predicted signals,

Clause 84. The method of clause 83, wherein the final prediction is determined based on the plurality of predicted signals, if a ratio of the second smallest cost to the smallest cost is less than a predetermined value.

Clause 85. The method of any of clauses 1-84, wherein whether a target chroma block of the video is coded with a decoder-side derivation of CCIP (DCCIP) is determined on-the-fly.

Clause 86. The method of clause 85, wherein the target chroma block is determined to be coded with DCCIP, if the target chroma block is not coded with a linear model mode.

Clause 87. The method of clause 85, wherein the target chroma block is determined to be coded with DCCIP, if the target chroma block is not coded with a planar mode, a DC mode, a horizontal mode, a vertical mode, a vertical diagonal mode and a chroma DM mode.

Clause 88. The method of any of clauses 1-84, wherein whether a target chroma block of the video is coded with DCCIP is determined based on at least one of: whether CCIP is allowed, block dimensions, a block size, a block depth, a slice type, a picture type, a partition tree type, a block location, or a color component.

Clause 89. The method of any of clauses 1-88, wherein information on DCCIP is indicated as a set of syntax elements in the bitstream.

Clause 90. The method of clause 89, wherein information on DCCIP for chroma components of the current chroma block is indicated in the bitstream by one syntax element of the set of syntax elements, or information on DCCIP for chroma components is indicated in the bitstream by a plurality of syntax elements of the set of syntax elements

Clause 91. The method of clause 90, wherein whether the chroma components are coded with DCCIP is dependent on the one syntax element, or whether the chroma components are coded with DCCIP is dependent on the plurality of syntax elements respectively.

Clause 92. The method of any of clauses 89-91, wherein the set of syntax elements are coded as a flag, or the set of syntax elements are binarized with one of the following: fixed length coding, truncated unary coding, unary coding, or exponential Golomb (EG) coding.

Clause 93. The method of any of clauses 89-91, wherein the set of syntax elements are bypass coded.

Clause 94. The method of any of clauses 89-91, wherein the set of syntax elements are context coded.

Clause 95. The method of clause 94, wherein a context for context coding of the set of syntax elements is dependent on coding information of the current chroma block or a set of neighboring blocks of the current chroma block.

Clause 96. The method of clause 95, wherein the coding information comprises at least one of: a block width, or a block height.

Clause 97. The method of clause 96, wherein a first context is used for the context coding if a product of the block width and the block height is smaller than or equal to a threshold, and a second context is used for context coding if the product of the block width and the block height is larger than the threshold, the second context being different from the first context.

Clause 98. The method of clause 96, wherein a first context is used for the context coding if a ratio of the block width to the block height is smaller than or equal to a threshold, and a second context is used for context coding if the ratio of the block width to the block height is larger than the threshold, the second context being different from the first context.

Clause 99. The method of any of clauses 95-98, wherein the coding information comprise a slice type.

Clause 100. The method of any of clauses 95-99, wherein the set of neighboring blocks comprise at least one of: a left block of the current chroma block, an above block of the current chroma block, a left-below block of the current chroma block, a right block of the current chroma block, or a left-above block of the current chroma block.

Clause 101. The method of any of clauses 95-100, wherein the coding information comprise whether the set of neighboring blocks are intra coded.

Clause 102. The method of any of clauses 95-100, wherein the coding information comprise whether the set of neighboring blocks are coded with DCCIP.

Clause 103. The method of any of clauses 95-102, wherein the coding information comprise partition information of the current chroma block or the set of neighboring blocks.

Clause 104. The method of any of clauses 89-103, wherein the set of syntax elements are indicated in the bitstream before or after one of: an indication of color space conversion, an indication of CCLM, an indication of MMLM, an indication of a planar mode, an indication of a DC mode, an indication of a horizontal mode, an indication of a vertical mode, or an indication of a vertical diagonal mode.

Clause 105. The method of any of clauses 1-88, wherein whether a set of syntax elements indicating information on DCCIP are indicated in the bitstream is dependent on coding information of the current chroma block or a set of neighboring blocks of the current chroma block.

Clause 106. The method of clause 105, wherein the coding information comprises at least one of: a block width, or a block height.

Clause 107. The method of clause 106, wherein the set of syntax elements are absent from the bitstream if a product of the block width and the block height is smaller than or equal to a first threshold.

Clause 108. The method of clause 106, wherein the set of syntax elements are absent from the bitstream if a product of the block width and the block height is larger than a second threshold.

Clause 109. The method of clause 106, wherein the set of syntax elements are absent from the bitstream if a ratio of the block width to the block height is smaller than or equal to a third threshold.

Clause 110. The method of clause 106, wherein the set of syntax elements are absent from the bitstream if a ratio of the block width to the block height is larger than a fourth threshold.

Clause 111. The method of any of clauses 105-110, wherein the coding information comprises a slice type or a picture type.

Clause 112. The method of any of clauses 105-111, wherein the coding information comprises at least one of: a prediction mode, or an intra coding tool.

Clause 113. The method of any of clauses 105-112, wherein the set of syntax elements are determined to be a predefined value if the set of syntax elements are absent from the bitstream.

Clause 114. The method of clause 113, wherein the predefined value is equal to 1 or 0.

Clause 115. The method of any of clauses 1-84, wherein a target chroma block of the video is coded with a coding tool other than DCCIP, if templates of the target chroma block are unavailable.

Clause 116. The method of any of clauses 1-84, wherein information on applying DCCIP to a target chroma block of the video is absent from the bitstream, if templates of the target chroma block are unavailable.

Clause 117. The method of any of clauses 1-84, wherein a target chroma block of the video is coded with a coding tool other than DCCIP, if at least one training samples of a template of the target chroma block is unavailable.

Clause 118. The method of any of clauses 1-84, wherein information on applying DCCIP to a target chroma block of the video is absent from the bitstream, if at least one training samples of a template of the target chroma block is unavailable.

Clause 119. The method of any of clauses 1-84, wherein whether a target chroma block of the video is allowed to be coded with DCCIP is dependent on a set of syntax elements.

Clause 120. The method of clause 119, wherein the set of syntax elements are indicated in the bitstream as general constraints information.

Clause 121. The method of clause 120, wherein the target chroma block is not allowed to be coded with DCCIP, if a syntax element of the set of syntax elements indicates general constrain on DCCIP is equal to a predetermined value.

Clause 122. The method of clause 121, wherein the predetermined value is equal to 1 or 0.

Clause 123. The method of any of clauses 119-112, wherein the set of syntax elements are included in one of: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 124. The method of any of clauses 1-123, wherein whether to and/or how to apply the method is indicated at one of: a sequence level, a group of pictures level, a picture level, a slice level, or a tile group level.

Clause 125. The method of any of clauses 1-123, wherein whether to and/or how to apply the method is indicated in one of: a sequence header, a picture header, a sequence parameter set (SPS), a video parameter set (VPS), a dependency parameter set (DPS), a decoding capability information (DCI), a picture parameter set (PPS), an adaptation parameter sets (APS), a slice header, or a tile group header.

Clause 126. The method of any of clauses 1-123, wherein whether to and/or how to apply the method is indicated at one of: a prediction block (PB), a transform block (TB), a coding block (CB), a prediction unit (PU), a transform unit (TU), a coding unit (CU), a virtual pipeline data unit (VPDU), a coding tree unit (CTU), a CTU row, a slice, a tile, a sub-picture, or a region containing more than one sample or pixel.

Clause 127. The method of any of clauses 1-123, further comprising: determining, based on coded information of the current chroma unit, whether to and/or how to apply the method, the coded information comprising at least one of: a block size, a color format, a single dual tree partitioning, a dual tree partitioning, a color component, a slice type, or a picture type.

Clause 128. The method of any of clauses 1-123, wherein the method is used in a coding tool requiring an intra prediction signal.

Clause 129. The method of any of clauses 1-128, wherein the conversion includes encoding the current chroma block into the bitstream.

Clause 130. The method of any of clauses 1-128, wherein the conversion includes decoding the current chroma block from the bitstream.

Clause 131. An apparatus for processing video data comprising a processor and a non-transitory memory with instructions thereon, wherein the instructions upon execution by the processor, cause the processor to perform a method in accordance with any of Clauses 1-130.

Clause 132. A non-transitory computer-readable storage medium storing instructions that cause a processor to perform a method in accordance with any of Clauses 1-130.

Clause 133. A non-transitory computer-readable recording medium storing a bitstream of a video which is generated by a method performed by a video processing apparatus, wherein the method comprises: determining a set of target modes of cross component intra prediction (CCIP) for a current chroma block of the video based on reconstructed samples or predicted samples of neighboring samples of the current chroma block; and generating the bitstream based on the set of target modes.

Clause 134. A method for storing a bitstream of a video, comprising: determining a set of target modes of cross component intra prediction (CCIP) for a current chroma block of the video based on reconstructed samples or predicted samples of neighboring samples of the current chroma block; generating the bitstream based on the set of target modes; and storing the bitstream in a non-transitory computer-readable recording medium.

### Example Device

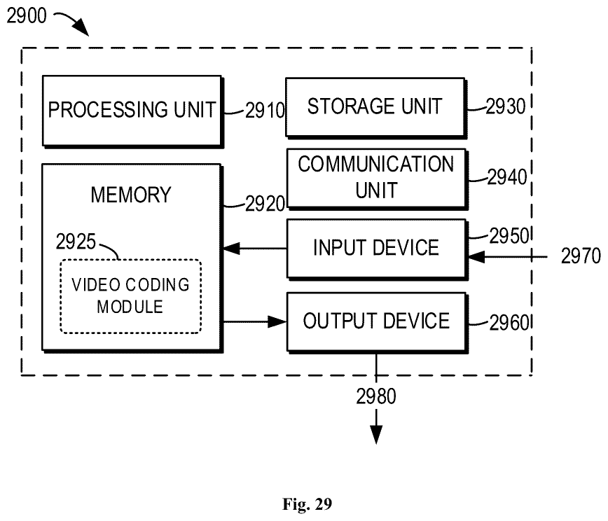

FIG. 29 illustrates a block diagram of a computing device 2900 in which various embodiments of the present disclosure can be implemented. The computing device 2900 may be implemented as or included in the source device 110 (or the video encoder 114 or 200) or the destination device 120 (or the video decoder 124 or 300).

It would be appreciated that the computing device 2900 shown in FIG. 29 is merely for purpose of illustration, without suggesting any limitation to the functions and scopes of the embodiments of the present disclosure in any manner.

As shown in FIG. 29, the computing device 2900 includes a general-purpose computing device 2900. The computing device 2900 may at least comprise one or more processors or processing units 2910, a memory 2920, a storage unit 2930, one or more communication units 2940, one or more input devices 2950, and one or more output devices 2960.

In some embodiments, the computing device 2900 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 2900 can support any type of interface to a user (such as “wearable” circuitry and the like).

The processing unit 2910 may be a physical or virtual processor and can implement various processes based on programs stored in the memory 2920. In a multi-processor system, multiple processing units execute computer executable instructions in parallel so as to improve the parallel processing capability of the computing device 2900. The processing unit 2910 may also be referred to as a central processing unit (CPU), a microprocessor, a controller or a microcontroller.

The computing device 2900 typically includes various computer storage medium. Such medium can be any medium accessible by the computing device 2900, including, but not limited to, volatile and non-volatile medium, or detachable and non-detachable medium. The memory 2920 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 2930 may be any detachable or non-detachable medium and may include a machine-readable medium such as a memory, flash memory drive, magnetic disk or another other media, which can be used for storing information and/or data and can be accessed in the computing device 2900.

The computing device 2900 may further include additional detachable/non-detachable, volatile/non-volatile memory medium. Although not shown in FIG. 29, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 2940 communicates with a further computing device via the communication medium. In addition, the functions of the components in the computing device 2900 can be implemented by a single computing cluster or multiple computing machines that can communicate via communication connections. Therefore, the computing device 2900 can operate in a networked environment using a logical connection with one or more other servers, networked personal computers (PCs) or further general network nodes.

The input device 2950 may be one or more of a variety of input devices, such as a mouse, keyboard, tracking ball, voice-input device, and the like. The output device 2960 may be one or more of a variety of output devices, such as a display, loudspeaker, printer, and the like. By means of the communication unit 2940, the computing device 2900 can further communicate with one or more external devices (not shown) such as the storage devices and display device, with one or more devices enabling the user to interact with the computing device 2900, or any devices (such as a network card, a modem and the like) enabling the computing device 2900 to communicate with one or more other computing devices, if required. Such communication can be performed via input/output (I/O) interfaces (not shown).

In some embodiments, instead of being integrated in a single device, some or all components of the computing device 2900 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 2900 may be used to implement video encoding/decoding in embodiments of the present disclosure. The memory 2920 may include one or more video coding modules 2925 having one or more program instructions. These modules are accessible and executable by the processing unit 2910 to perform the functionalities of the various embodiments described herein.

In the example embodiments of performing video encoding, the input device 2950 may receive video data as an input 2970 to be encoded. The video data may be processed, for example, by the video coding module 2925, to generate an encoded bitstream. The encoded bitstream may be provided via the output device 2960 as an output 2980.

In the example embodiments of performing video decoding, the input device 2950 may receive an encoded bitstream as the input 2970. The encoded bitstream may be processed, for example, by the video coding module 2925, to generate decoded video data. The decoded video data may be provided via the output device 2960 as the output 2980.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, during a conversion between a current chroma block of a video and a bitstream of the video, a set of target modes of cross component intra prediction (CCIP) for the current chroma block based on reconstructed samples or predicted samples of neighboring samples of the current chroma block; and
performing the conversion based on the set of target modes.

2. The method of claim 1, wherein the set of target modes are determined further based on residual information of the neighboring samples, or
wherein the neighboring samples are in the same color component of the current chroma block, or
wherein the neighboring samples are in different color components of the current chroma block, or
wherein determining the set of target modes comprises: determining the set of target modes based on a template comprising the reconstructed samples of the neighboring samples, or
wherein the CCIP comprises at least one of: cross-component linear model (CCLM), or multi-model linear model (MMLM), or
wherein a template used to determine the set of target modes comprises at least one of:
reconstructed samples adjacent to the current chroma block,
reconstructed samples non-adjacent to the current chroma block,
neighboring left-above reconstructed samples of the current chroma block,
neighboring left reconstructed samples of the current chroma block,
neighboring above reconstructed samples of the current chroma block,
neighboring left-below reconstructed samples of the current chroma block, or
neighboring right-above reconstructed samples of the current chroma block.

3. The method of claim 2, wherein determining the set of target modes based on the template comprises:
constructing a CCIP mode candidate list for the current chroma block; and
determining the set of target modes from the CCIP mode candidate list based on the template.

4. The method of claim 3, wherein the CCIP mode candidate list comprises at least one of:
a LM mode of cross-component linear model (CCLM),
a LM_T mode of CCLM,
a LM_L mode of CCLM,
a MMLM mode of multi-model linear model (MMLM),
a MMLM_T mode of MMLM, or
a MMLM_L mode of MMLM, or
wherein determining the set of target modes from the CCIP mode candidate list based on the template comprises:
determining costs for part of or all of modes in the CCIP mode candidate list based on the template; and
determining the set of target modes from the CCIP mode candidate list based on the costs.

5. The method of claim 4, wherein determining the set of target modes from the CCIP mode candidate list based on the costs comprises: determining a mode with the minimum cost in the CCIP mode candidate list to be a first target mode in the set of target modes, or
wherein determining the costs comprises:
determining a set of parameters for a model of a first mode in the CCIP mode candidate list based on training samples of the template;
determining predicted samples of the template based on the set of parameters and corresponding samples of the template, the corresponding samples being in a color component different from the template; and
determining a first cost for the first mode based on the predicted samples of the template and reconstructed samples of the template.

6. The method of claim 2, wherein a first set of training samples for determining parameters for a model of a first mode of CCIP for the template are the same as a second set of training samples for determining parameters for the model for the current chroma block.

7. The method of claim 6, wherein a shape of the template is the same as a shape of the current chroma block, or
a size of the template is the same as a size of the current chroma block, or
the number of training samples in the first set is the same as the number of training samples in the second set.

8. The method of claim 1, wherein the set of target modes comprise a first subset of target modes for a first chroma component of the current chroma block and a second subset of target modes for a second chroma component of the current chroma block, the first subset and the second subset being determined individually, or
wherein performing the conversion comprises:
determining predicted samples or reconstructed samples of at least one color component of the current chroma block based on the set of target modes of CCIP; and
performing the conversion based on the predicted samples or the reconstructed samples of the at least one color component, or
wherein performing the conversion comprises:
determining predicted samples or reconstructed samples of at least one color component of the current chroma block based on the set of target modes of CCIP; and
performing the conversion based on the predicted samples or the reconstructed samples of the at least one color component,
wherein the set of target modes comprise a plurality of target modes and the target mode used for the conversion is indicated in the bitstream, or the target mode used for the conversion is determined on-the-fly, or the target mode used for the conversion is dependent on coding information of the current chroma block or a set of neighboring blocks of the current chroma block.

9. The method of claim 8, wherein the first subset of target modes are determined in the same manner as the second subset of target modes.

10. The method of claim 1, wherein performing the conversion comprises:
determining a plurality of predicted signals for the current chroma block based on a plurality of IPMs;
determining a final prediction of the current chroma block based on the plurality of predicted signals; and
performing the conversion based on the final prediction.

11. The method of claim 10, wherein the plurality of IPMs comprise at least one of:
the set of target modes,
a further mode of CCIP, or
a target IPM.

12. The method of claim 1, wherein whether a target chroma block of the video is coded with a decoder-side derivation of CCIP (DCCIP) is determined on-the-fly, or
wherein whether a target chroma block of the video is coded with DCCIP is determined based on at least one of:
whether CCIP is allowed,
block dimensions,
a block size,
a block depth,
a slice type,
a picture type,
a partition tree type,
a block location, or
a color component, or
wherein information on DCCIP is indicated as a set of syntax elements in the bitstream.

13. The method of claim 12, wherein information on DCCIP for chroma components of the current chroma block is indicated in the bitstream by one syntax element of the set of syntax elements, or
information on DCCIP for chroma components is indicated in the bitstream by a plurality of syntax elements of the set of syntax elements.

14. The method of claim 1, wherein whether a target chroma block of the video is allowed to be coded with DCCIP is dependent on a set of syntax elements.

15. The method of claim 14, wherein the set of syntax elements are indicated in the bitstream as general constraints information, or
wherein the set of syntax elements are included in one of:
a sequence header,
a picture header,
a sequence parameter set (SPS),
a video parameter set (VPS),
a dependency parameter set (DPS),
a decoding capability information (DCI),
a picture parameter set (PPS),
an adaptation parameter sets (APS),
a slice header, or
a tile group header.

16. The method of claim 15, wherein the target chroma block is not allowed to be coded with DCCIP, if a syntax element of the set of syntax elements indicates general constrain on DCCIP is equal to a predetermined value.

17. The method of claim 1, wherein the conversion includes encoding the current chroma block into the bitstream, or
wherein the conversion includes decoding the current chroma block from the bitstream.

18. An apparatus for processing video data comprising a processor and a non-transitory memory with instructions thereon, wherein the instructions upon execution by the processor, cause the processor to:
determine, during a conversion between a current chroma block of a video and a bitstream of the video, a set of target modes of cross component intra prediction (CCIP) for the current chroma block based on reconstructed samples or predicted samples of neighboring samples of the current chroma block; and
perform the conversion based on the set of target modes.

19. A non-transitory computer-readable storage medium storing instructions that cause a processor to:
determine, during a conversion between a current chroma block of a video and a bitstream of the video, a set of target modes of cross component intra prediction (CCIP) for the current chroma block based on reconstructed samples or predicted samples of neighboring samples of the current chroma block; and
perform the conversion based on the set of target modes.

20. A non-transitory computer-readable recording medium storing a bitstream of a video which is generated by a method performed by a video processing apparatus, wherein the method comprises:
determining a set of target modes of cross component intra prediction (CCIP) for a current chroma block of the video based on reconstructed samples or predicted samples of neighboring samples of the current chroma block; and
generating the bitstream based on the set of target modes.
